(19) United States
(12) Patent Application Publication
(10) Pub. No.: US 2026/0254369 A1
(43) Pub. Date: Aug. 27, 2026

(54) POWER CONVERSION DEVICE

(71) Applicant: Mitsubishi Electric Corporation, Tokyo (JP)

(72) Inventors: Hiroyuki YOSHINO, Tokyo (JP); Satoshi OJIKA, Tokyo (JP); Shota WATANABE, Tokyo (JP); Hiroyasu IWABUKI, Tokyo (JP)

(73) Assignee: Mitsubishi Electric Corporation, Tokyo (JP)

(21) Appl. No.: 18/995,174

(22) PCT Filed: Aug. 2, 2022
(86) PCT No.: PCT/JP2022/029665

§ 371 Date: Jan. 16, 2025

(51) Int. Cl. H02M 7/5387; H02M 1/00

(52) U.S. Cl. CPC H02M 7/5387; H02M 1/0067

(57) ABSTRACT

An object is to suppress size increase and cost increase in a power conversion device that includes three or more single-phase inverters. A power conversion device includes: three or more single-phase inverters which convert DC power to AC power; and a control unit which controls the single-phase inverters. The three or more single-phase inverters are connected in series. Where absolute values of output voltages of the single-phase inverters are defined as voltage absolute values, the three or more single-phase inverters include at least two first common single-phase inverters which output first common voltages having the same voltage absolute value, and at least one single-phase inverter which outputs voltage having a smaller voltage absolute value than that of the first common voltages.

### TECHNICAL FIELD

The present disclosure relates to a power conversion device.

### BACKGROUND ART

As a power conversion device, there is known a power conversion device of a gradational control type which can output a smooth AC waveform to a load without needing a large-capacity output filter. The power conversion device of the gradational control type is configured with a plurality of single-phase inverters connected in series. As a conventional power conversion device of the gradational control type, a power conversion device in which the absolute values of output voltages of a plurality of single-phase inverters are respectively multiplied by approximately 2^{K} (K=0, 1, 2, . . . ), is disclosed. This power conversion device performs gradational control for total voltage of voltages outputted from the plurality of single-phase inverters, and outputs the resultant voltage to a load (see, for example, Patent Document 1).

### Citation List

### Patent Document

Patent Document 1: Japanese Laid-Open Patent Publication No. 2004-7941

### SUMMARY OF THE INVENTION

### Problem to be Solved by the Invention

However, in the conventional power conversion device, since the absolute values of the output voltages of the plurality of single-phase inverters are respectively multiplied by approximately 2^{K}, single-phase inverters that output great voltages are included. Therefore, the size of the single-phase inverter having greatest output voltage increases, and the sizes of components such as a heat dissipater for suppressing efficiency reduction in the single-phase inverter also increase. As a result, the conventional power conversion device has a problem of size increase and cost increase.

The present disclosure has been made to solve the above problem, and an object of the present disclosure is to provide a power conversion device that includes a plurality of single-phase inverters and enables suppression of size increase and cost increase.

### Means to Solve the Problem

A power conversion device according to the present disclosure includes: three or more single-phase inverters each of which converts DC power to AC power; and a control unit which controls the single-phase inverters. In the power conversion device according to the present disclosure, the three or more single-phase inverters are connected in series. Where absolute values of output voltages of the single-phase inverters are defined as voltage absolute values, the three or more single-phase inverters include at least two first common single-phase inverters which output first common voltages having the same voltage absolute value, and at least one single-phase inverter which outputs voltage having a smaller voltage absolute value than that of the first common voltages. The control unit outputs total voltage of the output voltages of the single-phase inverters to a load.

### Effect of the Invention

With the power conversion device according to the present disclosure, since the three or more single-phase inverters include at least two first common single-phase inverters which output the first common voltages having the same voltage absolute value, and at least one single-phase inverter which outputs voltage having a smaller voltage absolute value than that of the first common voltages, it is possible to suppress size increase and cost increase in the power conversion device.

### BRIEF DESCRIPTION OF THE DRAWINGS

FIG. 1 is a configuration diagram of a power conversion device according to embodiment 1.

FIG. 2 is a configuration diagram of a control unit and a single-phase inverter in the power conversion device according to embodiment 1.

FIG. 3 illustrates an example of control for the single-phase inverter in the power conversion device according to embodiment 1.

FIG. 4 illustrates output voltage waveforms of four single-phase inverters and a whole output voltage waveform in the power conversion device according to embodiment 1.

FIG. 5 illustrates combinations of four single-phase inverters for realizing outputs at gradation levels in the power conversion device according to embodiment 1.

FIG. 6 illustrates output voltage waveforms of four single-phase inverters and a whole output voltage waveform in a power conversion device of a comparative example with respect to embodiment 1.

FIG. 7 illustrates combinations of four single-phase inverters for realizing outputs at gradation levels in the power conversion device of the comparative example with respect to embodiment 1.

FIG. 8 is a table illustrating voltage configurations of the power conversion device according to embodiment 1.

FIG. 9 is a table illustrating voltage configurations of the power conversion device according to embodiment 1.

FIG. 10 illustrates output voltage waveforms of four single-phase inverters and a whole output voltage waveform in a power conversion device according to embodiment 2.

FIG. 11 illustrates combinations of four single-phase inverters for realizing outputs at gradation levels in the power conversion device according to embodiment 2.

FIG. 12 illustrates output voltage waveforms of four single-phase inverters and a whole output voltage waveform in the power conversion device according to embodiment 2.

FIG. 13 illustrates combinations of four single-phase inverters for realizing outputs at gradation levels in the power conversion device according to embodiment 2.

FIG. 14 is a table illustrating voltage configurations of the power conversion device according to embodiment 2.

FIG. 15 is a table illustrating voltage configurations of the power conversion device according to embodiment 2.

FIG. 16 is a configuration diagram of a power conversion device according to embodiment 3.

FIG. 17 is a circuit diagram of an output detection unit of the power conversion device according to embodiment 3.

FIG. 18 is a circuit diagram of an output detection unit of the power conversion device according to embodiment 3.

FIG. 19 is a configuration diagram of a gradational control signal generation unit of the power conversion device according to embodiment 3.

FIG. 20 illustrates combinations of four single-phase inverters for realizing outputs at gradation levels in the power conversion device according to embodiment 3.

FIG. 21 illustrates output voltage waveforms four single-phase inverters in the power conversion device according to embodiment 3.

FIG. 22 illustrates combinations of four single-phase inverters for realizing outputs at gradation levels in a power conversion device according to embodiment 4.

FIG. 23 is a flowchart showing a control method in the power conversion device according to embodiment 4.

FIG. 24 illustrates switching distribution processing in the power conversion device according to embodiment 4.

FIG. 25 illustrates combinations of four single-phase inverters for realizing outputs at gradation levels in the power conversion device according to embodiment 4.

FIG. 26 illustrates switching distribution processing in the power conversion device according to embodiment 4.

FIG. 27 is a configuration diagram of a power conversion device according to embodiment 5.

FIG. 28 illustrates combinations of four single-phase inverters for realizing outputs at gradation levels in the power conversion device according to embodiment 5.

FIG. 29 is a table illustrating voltage configurations of the power conversion device according to embodiment 5.

FIG. 30 is a table illustrating voltage configurations of the power conversion device according to embodiment 5.

FIG. 31 illustrates combinations of four single-phase inverters for realizing outputs at gradation levels in a power conversion device according to embodiment 6.

FIG. 32 is a flowchart showing a control method in the power conversion device according to embodiment 6.

FIG. 33 illustrates switching distribution processing in the power conversion device according to embodiment 6.

FIG. 34 illustrates combinations of four single-phase inverters for realizing outputs at gradation levels in the power conversion device according to embodiment 6.

FIG. 35 is a configuration diagram of a power conversion device according to embodiment 7.

FIG. 36 is a configuration diagram of a gradational control signal generation unit of the power conversion device according to embodiment 7.

FIG. 37 is a flowchart showing a control method in the power conversion device according to embodiment 7.

FIG. 38 illustrates voltage adjustment for DC power supplies in the power conversion device according to embodiment 7.

FIG. 39 illustrates voltage adjustment for the DC power supplies in the power conversion device according to embodiment 7.

FIG. 40 shows a hardware configuration for implementing the control unit of the power conversion device according to each of embodiments 1 to 7.

### DESCRIPTION OF EMBODIMENTS

Hereinafter, power conversion devices according to embodiments for carrying out the present disclosure will be described in detail, with reference to the drawings. In the drawings, the same reference characters denote the same or corresponding parts.

### Embodiment 1

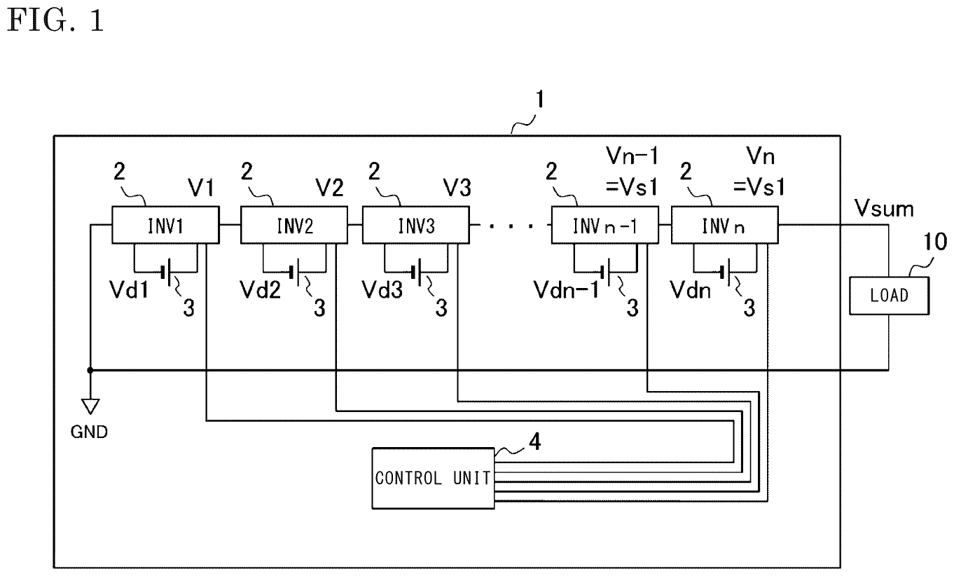

FIG. 1 is a configuration diagram of a power conversion device according to embodiment 1. A power conversion device 1 of the present embodiment includes three or more single-phase inverters 2 connected in series. In the power conversion device 1 shown in FIG. 1, n single-phase inverters 2 denoted by INV1, INV2, INV3, INVn−1, INVn are connected in series. Here, n is a natural number, DC power supplies 3 are respectively connected to the single-phase inverters 2. Output voltage of the DC power supply 3 connected to the single-phase inverter 2 for INVn is denoted by Vdn. Each single-phase inverter 2 converts DC power supplied from the DC power supply 3, to gradationally controlled AC power. The absolute value of generated voltage in voltage output of the single-phase inverter 2 for INV1 is denoted by V1, the absolute value of generated voltage in voltage output of the single-phase inverter 2 for INV2 is denoted by V2, and the absolute value of generated voltage in voltage output of the single-phase inverter 2 for INVn is denoted by Vn. Hereinafter, the absolute value of generated voltage in voltage output of each single-phase inverter 2 is referred to as a voltage absolute value. A control unit 4 is connected to each single-phase inverter 2. The control unit 4 controls each single-phase inverter 2, and performs control so as to output, as whole output voltage Vsum, the sum of output voltages of the single-phase inverters 2 from the power conversion device 1 to a load 10. The power conversion device 1 of the present embodiment is applicable to, as the load 10, various types of loads such as a resistive load, a capacitive load, an inductive load, and a combination thereof.

In the power conversion device 1 of the present embodiment, the voltage absolute values of two single-phase inverters among the plurality of single-phase inverters 2 are set at the same first common voltage Vs1. In the power conversion device 1 shown in FIG. 1, a voltage absolute value Vn−1 of the single-phase inverter for INVn−1 and a voltage absolute value Vn of the single-phase inverter for INVn are set at the same Vs1. The single-phase inverters of which the voltage absolute values are set at the first common voltage are referred to as first common single-phase inverters. The first common voltage Vs1 is set to be greater than the smallest value of the voltage absolute values V1, V2, V3, . . . , Vn−2 of the other single-phase inverters. The two first common single-phase inverters can output the first common voltage Vs1 at the same time.

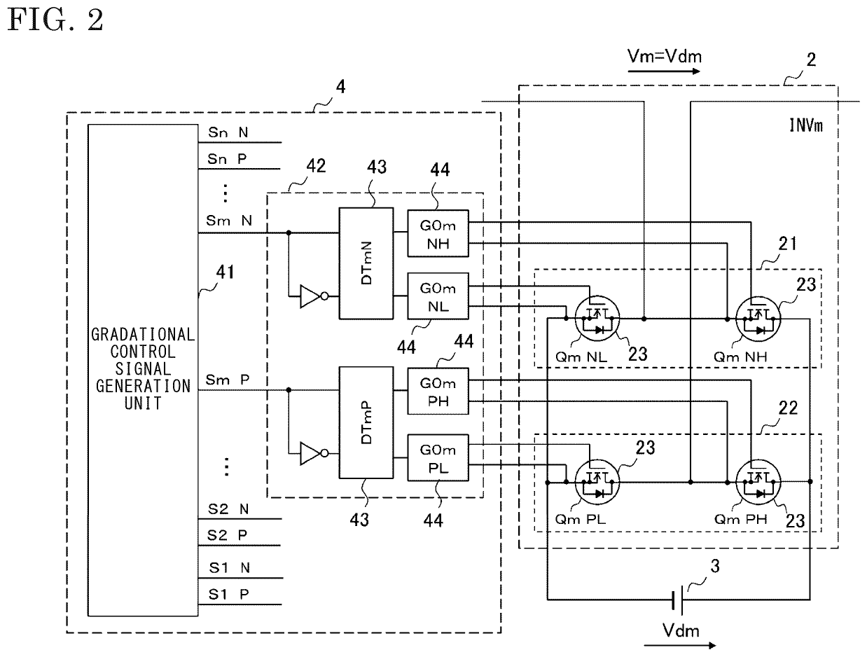

FIG. 2 is a configuration diagram of the control unit and the single-phase inverter in the power conversion device of the present embodiment. The single-phase inverter 2 for INVm is a full-bridge inverter having four switching elements 23 (QmNL, QmNH, QmPL, and QmPH). Here, m is a natural number from 1 to n. The full-bridge inverter is composed of one half-bridge inverter 21 formed by two switching elements QmNL and QmNH, and another half-bridge inverter 22 formed by two switching elements QmPL and QmPH. The DC power supply 3 having output voltage Vdm for which an arrow in FIG. 2 indicates a positive voltage direction is connected to the half-bridge inverters 21, 22. A capacitor may be provided between the DC power supply 3 and the single-phase inverter 2 for INVm.

The single-phase inverter 2 for INVm outputs voltage of which the voltage absolute value is Vm and for which an arrow in FIG. 2 indicates a positive voltage direction. In the present embodiment, it is assumed that resistance components of switching elements, wiring, and the like present between the DC power supply 3 and an output terminal of the single-phase inverter 2 are at negligible levels, and thus the output voltage Vm of the single-phase inverter 2 for INVm is regarded as the same as the output voltage Vdm of the DC power supply 3.

In FIG. 2, four switching elements 23 are shown as metal oxide semiconductor field effect transistors (MOSFETs). The switching elements 23 may be transistors, insulated gate bipolar transistors (IGBTs), or the like, instead of MOSFETs. In FIG. 2, one switching element 23 is formed by one component. However, in order to ensure withstand voltage and withstand current, one switching element 23 may be formed by a plurality of switching elements connected in series, connected in parallel, or connected in series and parallel in combination.

Gate driving signals are inputted from the control unit 4 to the two half-bridge inverters 21, 22 of the single-phase inverter 2 for INVm. The control unit 4 includes a gradational control signal generation unit 41 and a gate driver 42. The gradational control signal generation unit 41 generates gradational control signals SmN and SmP for performing gradational control of the single-phase inverter 2 for INVm. The gradational control signals SmN and SmP are inputted to the gate driver 42. The gate driver 42 provides dead times to the gradational control signals SmN and Smp by dead time generation units 43 (DTmN and DTmP). Then, the gate driver 42 outputs, as gate driving signals, gradational control signals with their levels shifted, from gate driving signal output units 44 (GOmNL, GOmNH, GOmPL, and GOmPH) to the two half-bridge inverters 21, 22. The two half-bridge inverters 21, 22 undergo gate driving by the gate driving signals.

In FIG. 2, the control unit 4 has a configuration for driving two half-bridge inverters by one gate driver 42. However, the control unit 4 may have two gate drivers for driving one half-bridge inverter. In FIG. 2, the gradational control signal generation unit 41 outputs the gradational control signals SmN and SmP one by one for control of the respective half-bridge inverters. As another configuration, the gradational control signal generation unit 41 may generate the gradational control signals SmN and SmP, and signals obtained by logically inverting the gradational control signals SmN and SmP, and output gradational control signals two by two for control of the respective half-bridge inverters. In this case, the dead time generation unit 43 (DTmN and DTmP) of the gate driver 42 may be omitted, and the gradational control signals may be outputted in a state in which dead times are provided to the gradational control signals logically inverted by the gradational control signal generation unit 41.

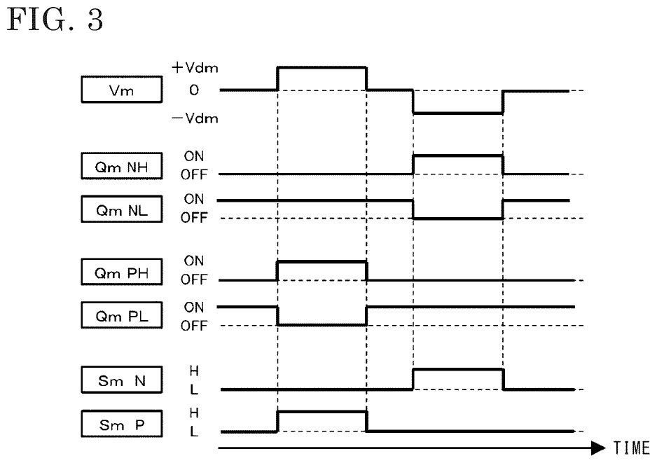

FIG. 3 illustrates an example of control for the single-phase inverter for INVm in the present embodiment. FIG. 3 shows change between an ON state and an OFF state of each of the four switching elements 23 (QmNL, QmNH, QmPL, and QmPH) composing the single-phase inverter for INVm with respect to the gradational control signals SmN and SmP, and change in the output voltage Vm of the single-phase inverter for INVm. In FIG. 3, the signals are shown with the dead times omitted.

As shown in FIG. 3, in a case where the gradational control signals SmN and SmP are both at a Low level (L), the switching elements QmNL and QmPL on the Low side of the half-bridge inverter are turned on, and the switching elements QmNH and QmPH on the High side are turned off, so that the single-phase inverter for INVm comes into a non-voltage output state (Vm=0 V). In a case where the gradational control signal SmN is at a Low level (L) and the gradational control signal SmP is at a High level (H), the switching element QmNL on the Low side of the half-bridge inverter is turned on and the switching element QmPL is turned off, and the switching element QmNH on the High side of the half-bridge inverter is turned off and the switching element QmPH is turned on. Thus, the single-phase inverter comes into a voltage output state, and the output voltage Vm becomes +Vdm (positive voltage). In a case where the gradational control signal SmN is at a High level (H) and the gradational control signal SmP is at a Low level (L), the switching element QmNL on the Low side of the half-bridge inverter is turned off and the switching element QmPL is turned on, and the switching element QmNH on the High side of the half-bridge inverter is turned on and the switching element QmPH is turned off. Thus, the single-phase inverter comes into a voltage output state, and the output voltage Vm becomes −Vdm (negative voltage).

The single-phase inverter shown in FIG. 2 has a configuration capable of outputting the output voltage Vm while switching the polarity thereof. In a case where the power conversion device outputs output voltage with only a single polarity to the load, the configuration of the single-phase inverter is not limited to that shown in FIG. 2. For example, in a case where the power conversion device outputs only positive voltage, the single-phase inverter may be configured with only the half-bridge inverter 22 while the switching element QmNH on the High side of the half-bridge inverter 21 in FIG. 2 is removed to form an open state and the drain and source terminals of the switching element QmNL on the Low side are short-circuited to each other (or QmNL may be removed).

Hereinafter, a control method in the power conversion device of the present embodiment will be described. For facilitating description, the power conversion device formed by four single-phase inverters will be described as an example. As a comparative example, a power conversion device in which the ratio of the voltage absolute values of output voltages of four single-phase inverters is 1:2:4:8 will also be described together.

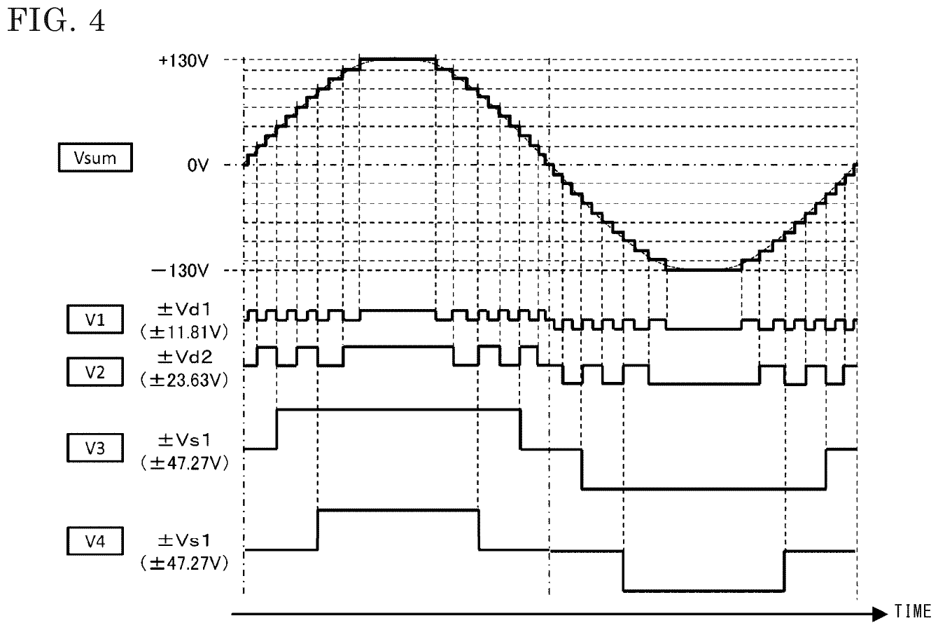

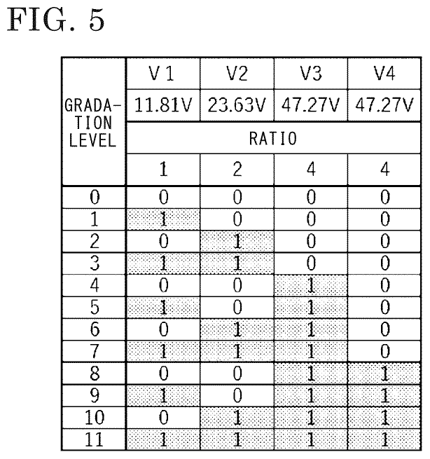

FIG. 4 illustrates output voltage waveforms of the four single-phase inverters which respectively output V1, V2, V3, and V4 in a case of using a sinewave as an output voltage command waveform, and a waveform of the whole output voltage Vsum that has undergone gradational control, in the power conversion device of the present embodiment. FIG. 5 is a table illustrating combinations of the voltage absolute values V1, V2, V3, and V4 of the four single-phase inverters for realizing outputs at gradation levels in the power conversion device of the present embodiment. In the power conversion device of the present embodiment, the ratio of the voltage absolute values V1, V2, V3, and V4 of the four single-phase inverters is 1:2:4:4. V1, V2, V3, and V4 are set so that the maximum voltage of the whole output voltage Vsum becomes ±130 V. Specifically, V1, V2, V3, and V4 are set as V1=11.81 V, V2=23.63 V, and V3=V4=47.27 V.

That is, the voltage absolute values of two single-phase inverters among the four single-phase inverters are set at the same first common voltage Vs1=47.27 V. In the table shown in FIG. 5, a state in which each of the four single-phase inverters is instructed to perform output at the corresponding voltage absolute value V1, V2, V3, and V4 is denoted by “1”, and a state of not being instructed to perform output is denoted by “0”. In a case where each single-phase inverter is instructed by the output instruction “1” during a period in which the waveform of the output voltage command is positive voltage, the single-phase inverter outputs positive voltage, and in a case where each single-phase inverter is instructed by the output instruction “1” during a period in which the waveform of the output voltage command is negative voltage, the single-phase inverter outputs negative voltage.

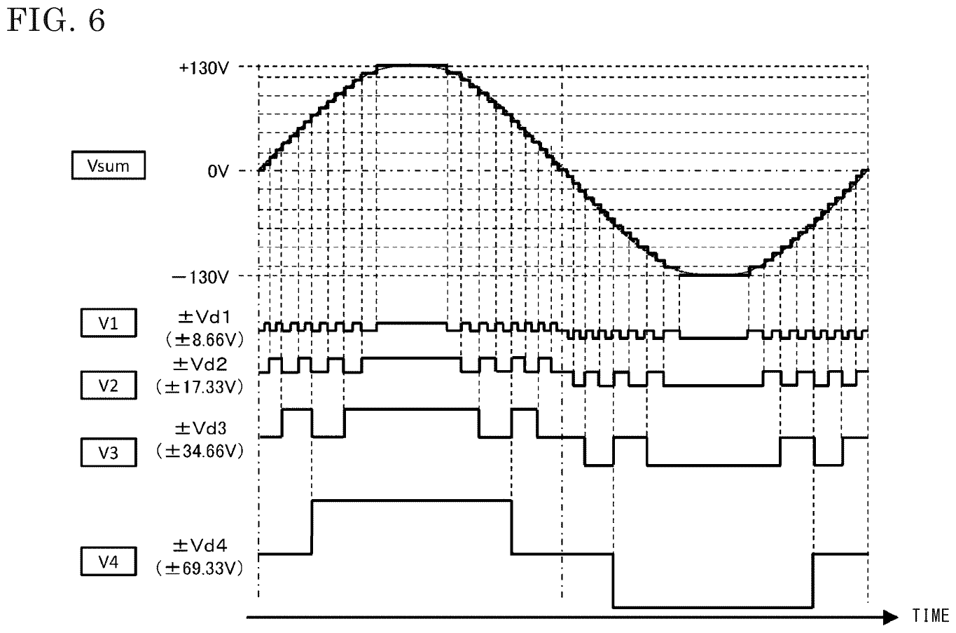

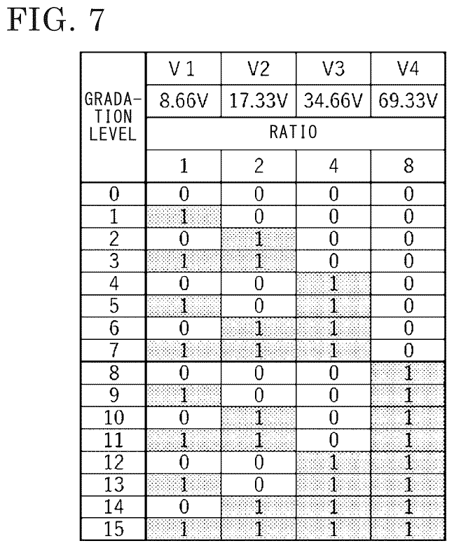

FIG. 6 illustrates waveforms of output voltages of the four single-phase inverters which respectively output V1, V2, V3, and V4 in a case of using a sinewave as an output voltage command waveform, and a waveform of the whole output voltage Vsum that has undergone gradational control, in the power conversion device of the comparative example. FIG. 7 is a table illustrating combinations of the voltage absolute values V1, V2, V3, and V4 of the four single-phase inverters for realizing outputs at gradation levels in the power conversion device of the comparative example. In the power conversion device of the comparative example, the ratio of the voltage absolute values V1, V2, V3, and V4 of the four single-phase inverters is 1:2:4:8. V1, V2, V3, and V4 are set so that the maximum voltage of the whole output voltage Vsum becomes ±130 V. Specifically, V1, V2, V3, and V4 are set as V1=8.66 V, V2=17.33 V, V3=34.66 V, and V4=69.33 V.

In the power conversion device of the present embodiment shown in FIG. 4 and FIG. 5, the single-phase inverters of which the voltage absolute values are greatest among the single-phase inverters are two single-phase inverters that output V3 and V4 which are set at the first common voltage Vs1=47.27 V. In consideration of a lineup of withstand voltages of general MOSFET switching elements, MOSFET switching elements of the single-phase inverters that output V3 and V4 need to have withstand voltage of 60 V or greater. Also, for the single-phase inverter that outputs V2 (23.63 V) which is the second greatest voltage, it is desirable that the same MOSFET switching element as that of the single-phase inverter that outputs V4 is used, in order to prevent accuracy deterioration in the waveform of Vsum due to differences in the switching speed and delay characteristics. Accordingly, in the power conversion device of the present embodiment, MOSFET switching elements having withstand voltages of 60 V or greater are needed for the two single-phase inverters that output V3 and V4.

On the other hand, in the power conversion device of the comparative example shown in FIG. 6 and FIG. 7, a single-phase inverter of which the voltage absolute value is greatest among the single-phase inverters is a single-phase inverter that outputs V4 which is set at 69.33 V. Therefore, in the power conversion device of the comparative example, 60 V is insufficient for the withstand voltages of the MOSFET switching elements of the single-phase inverter that outputs V4, and in consideration of a lineup of the withstand voltages of MOSFET switching elements, the one having withstand voltage of 80 V is needed. Also, for the single-phase inverter that outputs V3 (34.66 V) which is the second greatest voltage, it is desirable that the same MOSFET switching elements as that of the single-phase inverter that outputs V4 is used, in order to prevent accuracy deterioration in the waveform of Vsum. Accordingly, in the power conversion device of the comparative example, MOSFET switching elements having withstand voltages of 80 V or greater are needed for the two single-phase inverters that output V3 and V4.

In the power conversion device of the present embodiment and the power conversion device of the comparative example, since V1 and V2 are low voltages, a low-withstand-voltage MOSFET having withstand voltage of 30 V can be used for the MOSFET switching elements of the single-phase inverters that output V1 and V2.

When the output voltage waveform of the single-phase inverter that outputs V4 is compared between FIG. 4 and FIG. 6, the number of times of switching in the single-phase inverter that outputs V4 in one cycle of the sinewave of the output voltage command waveform is the same between the power conversion device of the present embodiment and the power conversion device of the comparative example. However, since voltage of V4 of the power conversion device of the present embodiment is smaller than voltage of V4 of the power conversion device of the comparative example, switching loss can be made smaller in the power conversion device of the present embodiment than in the power conversion device of the comparative example.

When the output voltage waveform of the single-phase inverter that outputs V3 is compared between FIG. 4 and FIG. 6, voltage of V3 of the power conversion device of the present embodiment is 1.36 times voltage of V3 of the power conversion device of the comparative example. However, the number of times of switching in the single-phase inverter that outputs V3 in one cycle of the sinewave of the output voltage command waveform is four in the power conversion device of the present embodiment, and twelve in the power conversion device of the comparative example. In view of both of the number of times of switching and the voltage values, also for the switching elements of the single-phase inverter that outputs V3, switching loss can be made smaller in the power conversion device of the present embodiment than in the power conversion device of the comparative example.

As described above, the power conversion device of the present embodiment is configured such that three or more single-phase inverters include at least two first common single-phase inverters that output the first common voltages having the same voltage absolute value and at least one single-phase inverter that outputs voltage having a smaller voltage absolute value than that of the first common voltages. Therefore, in the power conversion device of the present embodiment, MOSFET switching elements having lower withstand voltages than those in the power conversion device of the comparative example can be used. In addition, since MOSFET switching elements having low withstand voltages can be used in the power conversion device of the present embodiment, the ON resistance is smaller than in the power conversion device of the comparative example, so that conduction loss can be reduced. Further, in the power conversion device of the present embodiment, switching loss can be made smaller than in the power conversion device of the comparative example. Voltages of the DC power supplies connected to the first common single-phase inverters are also reduced, and therefore, low-withstand-voltage elements can be used also for capacitors and the like connected in parallel to the DC power supply and provided in the first common single-phase inverters, for example. As a result, the power conversion device of the present embodiment can be formed using a small-sized single-phase inverter and a small-sized heat dissipater, whereby size increase and cost increase in the power conversion device can be suppressed.

It is necessary that the first common voltage is not the smallest value of the voltage absolute values of the single-phase inverters. This is because, in a case where the first common voltage is set at the smallest value of the voltage absolute values of the single-phase inverters, the greatest voltage of outputs of the single-phase inverters cannot be reduced unless the number of gradation levels is greatly decreased. In the power conversion device of the present embodiment, since the first common voltage is set at the greatest value of the voltage absolute values of the single-phase inverters, it is possible to suppress size increase and cost increase in the power conversion device without greatly decreasing the number of gradation levels.

In the above description, the power conversion device of the present embodiment has been described as a power conversion device formed by four single-phase inverters. However, the power conversion device of the present embodiment may be formed by three or more single-phase inverters. Hereinafter, the characteristics of the power conversion device of the present embodiment formed by three to five single-phase inverters will be described, For comparison, the characteristics of a power conversion device of a comparative example in which the absolute values of output voltages of a plurality of single-phase inverters are respectively multiplied by approximately 2^{K} (K=0, 1, 2, . . . ) will also be described together.

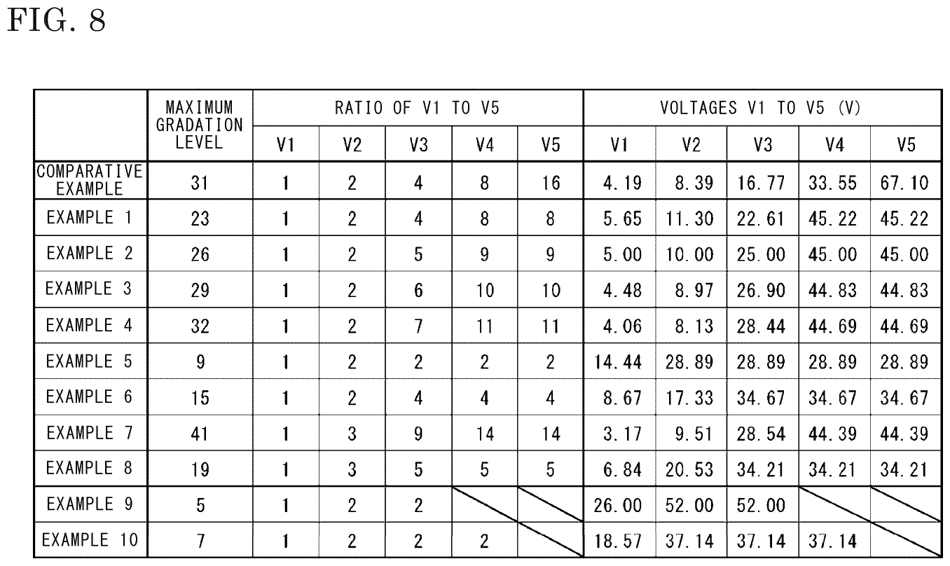

FIG. 8 is a table illustrating voltage configurations of the power conversion device of the present embodiment formed by three to five single-phase inverters. The table in FIG. 8 shows the voltage ratio of V1 to V5 and voltages of V1 to V5. The voltages of V1 to V5 are set so that the whole output voltage Vsum becomes ±130 V. As shown in FIG. 8, in the power conversion device of the comparative example, the voltage ratio is set as V1:V2:V3:V4:V5=1:2:4:8:16.

As the power conversion device of the present embodiment, power conversion devices of Examples 1 to 8 are formed by five single-phase inverters, a power conversion device of Example 9 is formed by three single-phase inverters, and a power conversion device of Example 10 is formed by four single-phase inverters. In the power conversion device of Example 1, the voltage ratio is set as V1:V2:V3:V4:V5=1:2:4:8:8. In the power conversion device of Example 2, the voltage ratio is set as V1:V2:V3:V4:V5=1:2:5:9:9. In the power conversion device of Example 3, the voltage ratio is set as V1:V2:V3:V4:V5=1:2:6:10:10. In the power conversion device of Example 4, the voltage ratio is set as V1:V2:V3:V4:V5=1:2:7:11:11. In the power conversion device of Example 5, the voltage ratio is set as V1:V2:V3:V4:V5=1:2:2:2:2. In the power conversion device of Example 6, the voltage ratio is set as V1:V2:V3:V4:V5=1:2:4:4:4. In the power conversion device of Example 7, the voltage ratio is set as V1:V2:V3:V4:V5=1:3:9:14:14. In the power conversion device of Example 8, the voltage ratio is set as V1:V2:V3:V4:V5=1:3:5:5:5. In the power conversion device of Example 9, the voltage ratio is set as V1:V2:V3=1:2:2. In the power conversion device of Example 10, the voltage ratio is set as V1:V2:V3:V4=1:2:2:2. The power conversion devices of Examples 1 to 10 are each configured such that the voltage ratios include 1 and 2 or the voltage ratios include 1 and 3.

The greatest voltages of the single-phase inverters in the power conversion devices of Examples 1 to 10 shown in FIG. 8 are smaller than the greatest voltage of the single-phase inverters in the power conversion device of the comparative example. Therefore, in the power conversion devices of Examples 1 to 10, MOSFET switching elements having lower withstand voltages than those in the power conversion device of the comparative example can be used.

Here, in Example 2 and Example 7, in order to realize each gradation level, there is a case where a plurality of single-phase inverters need to output voltages having different polarities at the same time. For example, in Example 2, the single-phase inverter that outputs V1 of which the ratio of the voltage absolute value is 1 outputs negative voltage, and the single-phase inverter that outputs V3 of which the ratio of the voltage absolute value is 5 outputs positive voltage, whereby a gradation level 4 can be realized (5−1=4). In Example 7, the single-phase inverter that outputs V1 of which the ratio of the voltage absolute value is 1 outputs negative voltage, the single-phase inverter that outputs V2 of which the ratio of the voltage absolute value is 3 outputs negative voltage, and the single-phase inverter that outputs V3 of which the ratio of the voltage absolute value is 9 outputs positive voltage, whereby a gradation level 5 can be realized (9−3-1=5).

Thus, the power conversion devices of Examples 1 to 10 shown in FIG. 8 can output AC power to a load in ranges not higher than their respective maximum gradation levels. Here, with respect to the smallest ratio 1 among the voltage absolute values, the ratio of the first common voltage is defined as J, and the sum of the ratios of the voltage absolute values smaller than the ratio J is defined as K. For example, in Example 2, J is 9 and K is 1+2+5=8, so that J and K have a relationship of J=K+1. In Example 7, J is 14 and K is 1+3+9=13, so that J and K have a relationship of J=K+1. Thus, in all the power conversion devices of Examples 1 to 10, the relationship of J=K+1 is satisfied. With the configuration satisfying such a relationship, the power conversion device of the present embodiment can be formed by a smaller number of single-phase inverters while avoiding overlap between combinations for realizing outputs at the respective gradation levels, and in addition, MOSFET switching elements having lower withstand voltages than those in the power conversion device of the comparative example can be used. Thus, size increase and cost increase in the power conversion device can be suppressed.

The relationship of J and K is satisfied also in the power conversion device formed by three single-phase inverters in Example 9 and the power conversion device formed by four single-phase inverters in Example 10. The relationship of J and K is satisfied also in a power conversion device formed by six or more single-phase inverters.

In the power conversion devices of Examples 1 to 10, the greatest output voltage of the single-phase inverters is used as the first common voltage. In the power conversion device of the present embodiment, the first common voltage may not necessarily be the greatest output voltage of the single-phase inverters.

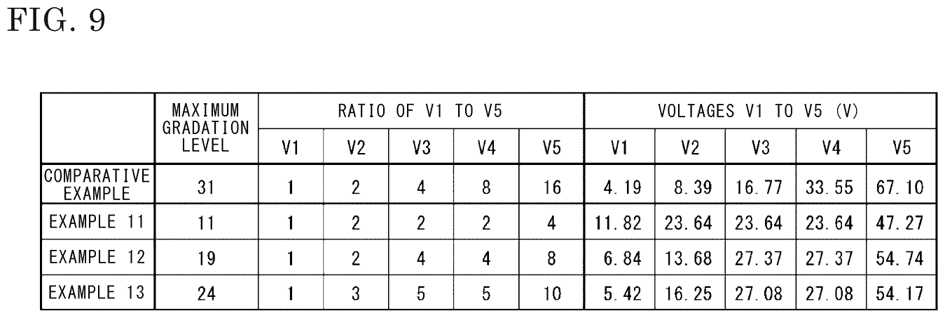

FIG. 9 is a table illustrating voltage configurations of the power conversion device according to the present embodiment formed by five single-phase inverters. The table in FIG. 9 shows the voltage ratio of V1 to V5 and voltages of V1 to V5. The voltages of V1 to V5 are set so that the whole output voltage Vsum is ±130 V. In FIG. 9, the power conversion device of the comparative example in which the voltage ratio is set as V1:V2:V3:V4:V5=1:2:4:8:16 is also shown.

In the power conversion device of Example 11 shown in FIG. 9, the voltage ratio is set as V1:V2:V3:V4:V5=1:2:2:2:4. In the power conversion device of Example 12, the voltage ratio is set as V1:V2:V3:V4:V5=1:2:4:4:8. In the power conversion device of Example 13, the voltage ratio is set as V1:V2:V3:V4:V5=1:3:5:5:10. In the power conversion devices of Examples 11 to 13, the first common voltage is not the greatest output voltage of the single-phase inverters.

The greatest voltages of the single-phase inverters in the power conversion devices of Examples 11 to 13 shown in FIG. 9 are smaller than the greatest voltage of the single-phase inverters in the power conversion device of the comparative example. Therefore, in the power conversion devices of Examples 11 to 13, MOSFET switching elements having lower withstand voltages than those in the power conversion device of the comparative example can be used.

Also in the power conversion devices of Examples 11 to 13 shown in FIG. 9, the relationship of J=K+1 is satisfied. For example, in Example 12, J is 4 and K is 1+2=3, so that the relationship of J=K+1 is satisfied.

### Embodiment 2

In the power conversion device according to embodiment 1, with respect to the smallest ratio 1 among the voltage absolute values, the ratio of the first common voltage is defined as J and the sum of the ratios of the voltage absolute values smaller than the ratio J is defined as K, and then the relationship of J=K+1 is satisfied. In embodiment 2, a power conversion device in which a relationship of J=2K+1 is satisfied will be described.

The configuration of the power conversion device of the present embodiment is the same as the configuration of the power conversion device shown in FIG. 1 in embodiment 1. In the power conversion device of the present embodiment, output voltages of a plurality of single-phase inverters are different from those in the power conversion device of embodiment 1. For facilitating description, the power conversion device formed by four single-phase inverters will be described as an example.

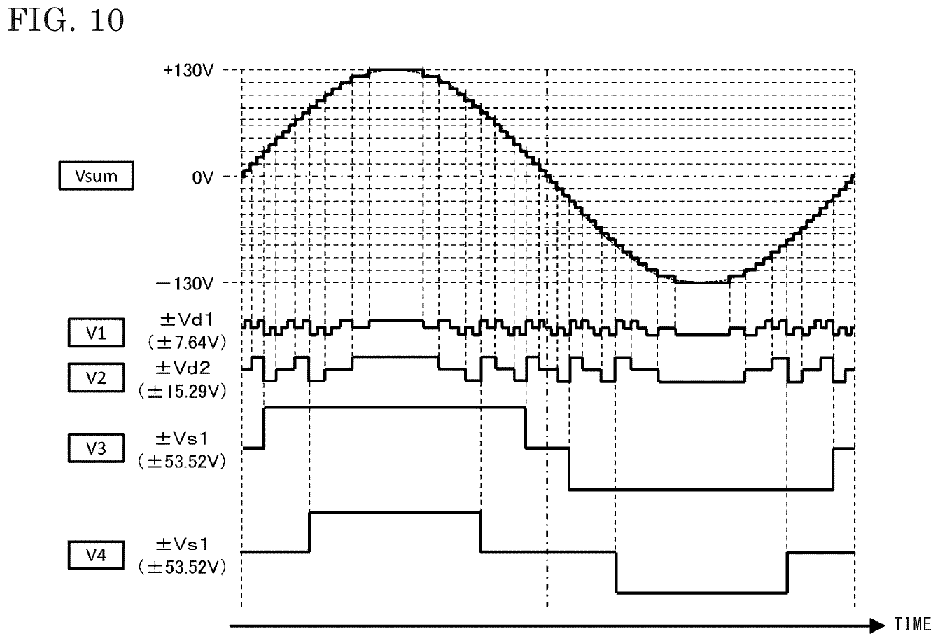

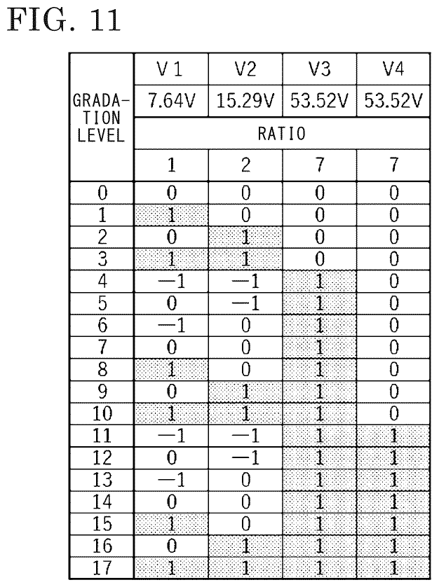

FIG. 10 illustrates output voltage waveforms of the four single-phase inverters which respectively output V1, V2, V3, and V4 in a case of using a sinewave as an output voltage command waveform, and a waveform of the whole output voltage Vsum that has undergone gradational control, in the power conversion device of the present embodiment. FIG. 11 is a table illustrating combinations of the voltage absolute values V1, V2, V3, and V4 of the four single-phase inverters for realizing outputs at gradation levels in the power conversion device of the present embodiment. In the power conversion device of the present embodiment, the ratio of the voltage absolute values V1, V2, V3, and V4 of the four single-phase inverters is 1:2:7:7. V1, V2, V3, and V4 are set so that the maximum voltage of the whole output voltage Vsum becomes ±130 V. Specifically, V1, V2, V3, and V4 are set as V1=7.64 V, V2=15.29 V, and V3=V4=53.52 V. That is, the voltage absolute values of two single-phase inverters among the four single-phase inverters are set at the same first common voltage Vs1=53.52 V. In the table shown in FIG. 11, a state in which each of the four single-phase inverters is instructed to perform output at the corresponding voltage absolute value V1, V2, V3, and V4 is denoted by “1” or “−1”, and a state of not being instructed to perform output is denoted by “0”. In a case where each single-phase inverter is instructed by the output instruction “1” during a period in which the waveform of the output voltage command is positive voltage, the single-phase inverter outputs positive voltage, and in a case where each single-phase inverter is instructed by the output instruction “−1” during the period, the single-phase inverter outputs negative voltage. In a case where each single-phase inverter is instructed by the output instruction “1” during a period in which the waveform of the output voltage command is negative voltage, the single-phase inverter outputs negative voltage, and in a case where each single-phase inverter is instructed by the output instruction “−1” during the period, the single-phase inverter outputs positive voltage.

In the power conversion device of the present embodiment, the ratio of the voltage absolute values V1, V2, V3, and V4 of the four single-phase inverters is 1:2:7:7. In this case, J is 7 and K is 3, so that the relationship of J=2K+1 is satisfied. In the power conversion device shown in FIG. 4 and FIG. 5 in embodiment 1, the ratio of the voltage absolute values V1, V2, V3, and V4 of the four single-phase inverters is 1:2:4:4. In this power conversion device, the relationship of J=K+1 is satisfied. In addition, in this power conversion device, the maximum gradation level is 11. On the other hand, in the power conversion device of the present embodiment in which the relationship of J=2K+1 is satisfied, the maximum gradation level is 17. Therefore, in the power conversion device of the present embodiment, a maximum gradation level higher than in the power conversion device of embodiment 1 can be achieved.

The greatest voltage of the single-phase inverters in the power conversion device of the present embodiment is smaller than the greatest voltage of the single-phase inverters in the power conversion device of the comparative example described in embodiment 1. Therefore, in the power conversion device of the present embodiment, MOSFET switching elements having lower withstand voltages than those in the power conversion device of the comparative example can be used, whereby conduction loss can be reduced.

When the output voltage waveform of the single-phase inverter that outputs V4 is compared between FIG. 6 and FIG. 10, the number of times of switching in the single-phase inverter that outputs V4 in one cycle of the sinewave of the output voltage command waveform is the same between the power conversion device of the present embodiment and the power conversion device of the comparative example. However, since voltage of V4 of the power conversion device of the present embodiment is smaller than voltage of V4 of the power conversion device of the comparative example, switching loss can be made smaller in the power conversion device of the present embodiment than in the power conversion device of the comparative example.

When the output voltage waveform of the single-phase inverter that outputs V3 is compared between FIG. 6 and FIG. 10, voltage of V3 of the power conversion device of the present embodiment is 1.54 times voltage of V3 of the power conversion device of the comparative example. However, the number of times of switching in the single-phase inverter that outputs V3 in one cycle of the sinewave of the output voltage command waveform is four in the power conversion device of the present embodiment, and twelve in the power conversion device of the comparative example. In view of both of the number of times of switching and the voltage values, also for the switching element of the single-phase inverter that outputs V3, switching loss can be made smaller in the power conversion device of the present embodiment than in the power conversion device of the comparative example.

When the output voltage waveforms of the single-phase inverters that output V1 and V2 are compared between FIG. 6 and FIG. 10, the numbers of times of switching in the single-phase inverters that output V1 and V2 in one cycle of the sinewave of the output voltage command waveform are larger in the power conversion device of the present embodiment than in the power conversion device of the comparative example. However, since V1 and V2 are sufficiently lower voltages than V3 and V4, switching loss in the single-phase inverters that output V1 and V2 is smaller than switching loss in the single-phase inverters that output V3 and V4. Thus, whole switching loss in the four single-phase inverters is smaller in the power conversion device of the present embodiment than in the power conversion device of the comparative example.

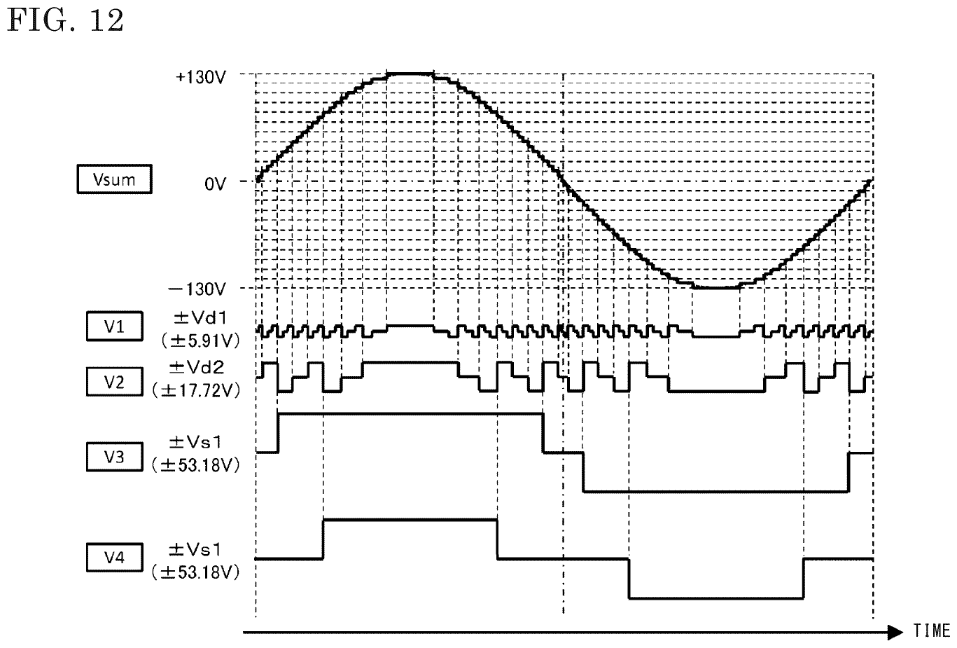

FIG. 12 illustrates output voltage waveforms of the four single-phase inverters which respectively output V1, V2, V3, and V4 in a case of using a sinewave as an output voltage command waveform, and a waveform of the whole output voltage Vsum that has undergone gradational control, in the power conversion device of the present embodiment. FIG. 13 is a table illustrating combinations of the voltage absolute values V1, V2, V3, and V4 of the four single-phase inverters for realizing outputs at gradation levels in the power conversion device of the present embodiment. In the power conversion device of the present embodiment, the ratio of the voltage absolute values V1, V2, V3, and V4 of the four single-phase inverters is 1:3:9:9. V1, V2, V3, and V4 are set so that the maximum voltage of the whole output voltage Vsum becomes ±130 V. Specifically, V1, V2, V3, and V4 are set as V1=5.91 V, V2=17.72 V, and V3=V4=53.18 V. That is, the voltage absolute values of two single-phase inverters among the four single-phase inverters are set at the same first common voltage Vs1=53.18 V.

In the power conversion device of the present embodiment, the ratio of the voltage absolute values V1, V2, V3, and V4 of the four single-phase inverters is 1:3:9:9, In this case, J is 9 and K is 4, so that the relationship of J=2K+1 is satisfied. In the power conversion device of the present embodiment in which the relationship of J=2K+1 is satisfied, the maximum gradation level is 22. Therefore, in the power conversion device of the present embodiment, a maximum gradation level higher than in the power conversion device of embodiment 1 can be achieved.

The greatest voltage of the single-phase inverters in the power conversion device of the present embodiment is smaller than the greatest voltage of the single-phase inverters in the power conversion device of the comparative example described in embodiment 1. Therefore, in the power conversion device of the present embodiment, MOSFET switching elements having lower withstand voltages than those in the power conversion device of the comparative example can be used, whereby conduction loss can be reduced.

In the above description, the power conversion device of the present embodiment has been described as a power conversion device formed by four single-phase inverters. However, the power conversion device of the present embodiment may be formed by three or more single-phase inverters. Hereinafter, the characteristics of the power conversion device of the present embodiment formed by three to five single-phase inverters will be described. For comparison, the characteristics of a power conversion device of a comparative example in which the absolute values of output voltages of a plurality of single-phase inverters are respectively multiplied by approximately 2^{K} (K=0, 1, 2, . . . ) will also be described together.

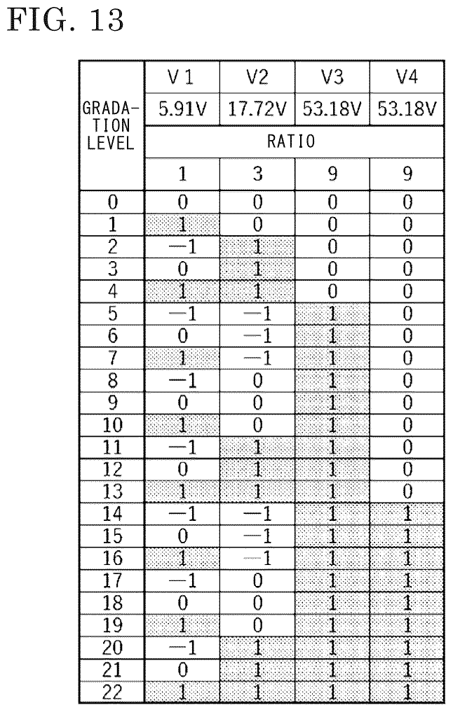

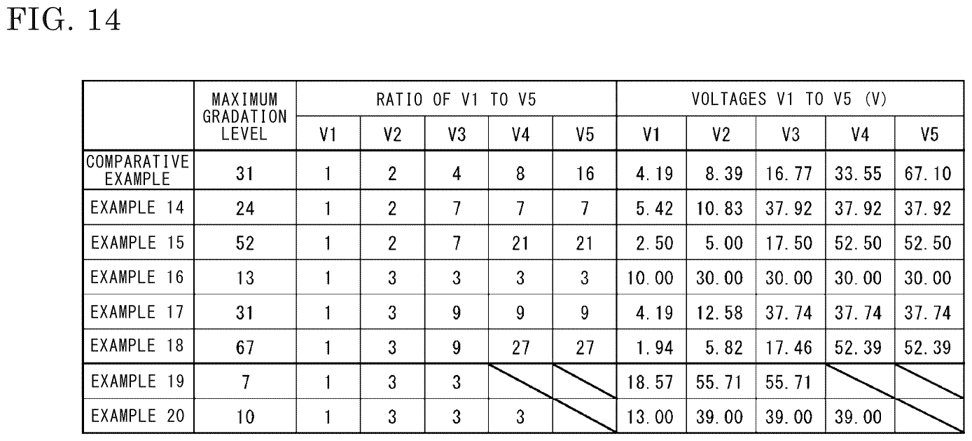

FIG. 14 is a table illustrating voltage configurations of the power conversion device of the present embodiment formed by three to five single-phase inverters.

The table in FIG. 14 shows the voltage ratio of V1 to V5 and voltages of V1 to V5. The voltages of V1 to V5 are set so that the whole output voltage Vsum becomes ±130 V. As shown in FIG. 14, in the power conversion device of the comparative example, the voltage ratio is set as V1:V2:V3:V4:V5=1:2:4:8:16.

As the power conversion device of the present embodiment, power conversion devices of Examples 14 to 18 are formed by five single-phase inverters, a power conversion device of Example 19 is formed by three single-phase inverters, and a power conversion device of Example 20 is formed by four single-phase inverters. In the power conversion device of Example 14, the voltage ratio is set as V1:V2:V3:V4:V5=1:2:7:7:7. In the power conversion device of Example 15, the voltage ratio is set as V1:V2:V3:V4:V5=1:2:7:21:21. In the power conversion device of Example 16, the voltage ratio is set as V1:V2:V3:V4:V5=1:3:3:3:3. In the power conversion device of Example 17, the voltage ratio is set as V1:V2:V3:V4:V5=1:3:9:9:9. In the power conversion device of Example 18, the voltage ratio is set as V1:V2:V3:V4:V5=1:3:9:27:27. In the power conversion device of Example 19, the voltage ratio is set as V1:V2:V3=1:3:3. In the power conversion device of Example 20, the voltage ratio is set as V1:V2:V3:V4=1:3:3:3. The power conversion devices of Examples 14 to 20 are each configured such that the voltage ratios include 1 and 2 or the voltage ratios include 1 and 3.

The greatest voltages of the single-phase inverters in the power conversion devices of Examples 14 to 20 shown in FIG. 14 are smaller than the greatest voltage of the single-phase inverters in the power conversion device of the comparative example. Therefore, in the power conversion device of Examples 11 to 20, MOSFET switching elements having lower withstand voltages than those in the power conversion device of the comparative example can be used.

In the power conversion devices of Examples 14 to 20, the relationship of J=2K+1 is satisfied. Therefore, under the condition in which the greatest voltage of the single-phase inverters is substantially the same, a maximum gradation level higher than in the power conversion device of embodiment 1 can be achieved in the power conversion devices of Examples 11 to 20. In the power conversion device of Example 17 in which the voltage ratio is set as V1:V2:V3:V4:V5=1:3:9:9:9, the maximum gradation level is 31 which is equal to the maximum gradation level in the comparative example, and the voltage absolute values of three single-phase inverters are greatest voltage of 37.74 V, which is approximately half the greatest voltage of 67.1 V in the comparative example. Therefore, in the power conversion device of Example 17, the effects of reducing conduction loss and switching loss in the MOSFETs relative to the power conversion device of the comparative example are greatest.

Thus, with the configuration in which the ratios of the voltage absolute values include 1, 3, and 9 and the voltage for the ratio 9 is set as the first common voltage, it is possible to provide a power conversion device having many gradation levels while achieving size reduction and cost reduction.

In the power conversion devices of Examples 14 to 20, the greatest output voltage of the single-phase inverters is used as the first common voltage. In the power conversion device of the present embodiment, the first common voltage may not necessarily be the greatest output voltage of the single-phase inverters.

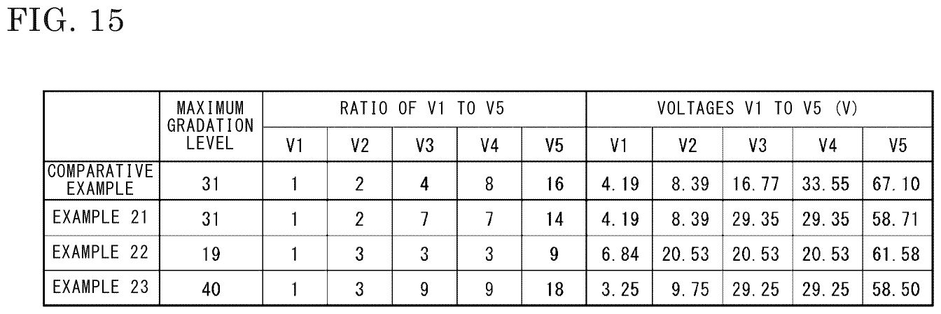

FIG. 15 is a table illustrating voltage configurations of the power conversion device according to the present embodiment formed by five single-phase inverters. The table in FIG. 15 shows the voltage ratio of V1 to V5 and voltages of V1 to V5. The voltages of V1 to V5 are set so that the whole output voltage Vsum is ±130 V. In FIG. 15, the power conversion device of the comparative example in which the voltage ratio is set as V1:V2:V3:V4:V5=1:2:4:8:16 is also shown.

In the power conversion device of Example 21 shown in FIG. 15, the voltage ratio is set as V1:V2:V3:V4:V5=1:2:7:7:14. In the power conversion device of Example 22, the voltage ratio is set as V1:V2:V3:V4:V5=1:3:3:3:9. In the power conversion device of Example 23, the voltage ratio is set as V1:V2:V3:V4:V5=1:3:9:9:18. In the power conversion devices of Examples 21 to 23, the first common voltage is not the greatest output voltage of the single-phase inverters.

The greatest voltages of the single-phase inverters in the power conversion devices of Examples 21 to 23 shown in FIG. 15 are smaller than the greatest voltage of the single-phase inverters in the power conversion device of the comparative example. Therefore, in the power conversion devices of Examples 21 to 23, MOSFET switching elements having lower withstand voltages than those in the power conversion device of the comparative example can be used.

### Embodiment 3

In the power conversion devices of embodiments 1 and 2, gradational control is performed using the smallest ratio 1 among the voltage absolute values as a unit of gradation levels of the whole output voltage Vsum. The unit that is the smallest ratio 1 among the voltage absolute values is referred to as 1 level, for convenience sake, In a power conversion device of embodiment 3, at least one of a plurality of single-phase inverters is subjected to pulse width modulation (PWM) control, whereby gradational control is performed such that a unit of gradation levels of the whole output voltage Vsum is equivalently made smaller than 1 level.

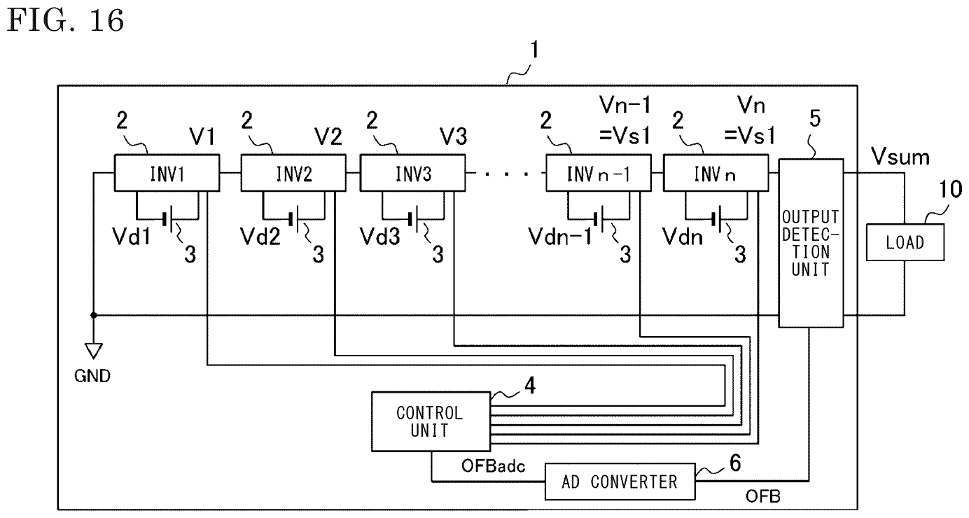

FIG. 16 is a configuration diagram of the power conversion device according to the present embodiment. The power conversion device of the present embodiment has an output detection unit 5 and an AD converter (analog to digital converter) 6 in addition to the configuration of the power conversion device shown in FIG. 1 in embodiment 1. The output detection unit 5 detects at least one of voltage or current outputted to the load 10, and outputs a negative-feedback signal. Hereinafter, the negative-feedback signal is referred to as an OFB (output feedback). The AD converter 6 converts the OFB outputted from the output detection unit 5, to a digital negative-feedback signal, and outputs the digital negative feedback signal to the control unit 4. Hereinafter, the digital-converted negative-feedback signal is referred to as an OFBadc. However, in a case where a first subtractor provided inside the control unit 4, described later, is formed by an analog circuit, the AD converter 6 may be omitted.

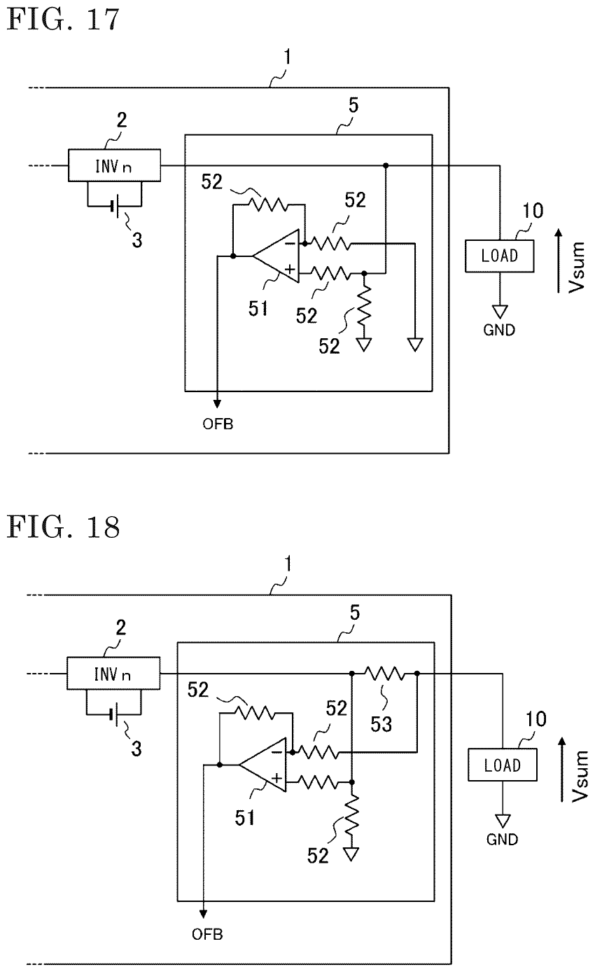

FIG. 17 is a circuit diagram of the output detection unit for detecting voltage outputted to the load. The output detection unit 5 is provided between the single-phase inverter 2 and an output terminal to the load 10. The output detection unit 5 includes a differential circuit composed of an operational amplifier 51 and a plurality of resistors 52. The output detection unit 5 detects differential voltage from voltage applied to the load and outputs the OFB.

FIG. 18 is a circuit diagram of the output detection unit for detecting current flowing to the load. The output detection unit 5 is provided between the single-phase inverter 2 and an output terminal of the load 10. The output detection unit 5 includes a current detection resistor 53 connected in series to the load 10, and a differential circuit composed of an operational amplifier 51 and a plurality of resistors 52. The output detection unit 5 detects differential voltage from voltage across the current detection resistor 53 and outputs the OFB. The current detection resistor 53 may be provided between the load 10 and a ground potential (GND).

The output detection unit 5 of the power conversion device 1 of the present embodiment includes at least one of the circuits shown in FIG. 17 and FIG. 18. In a case where the output detection unit 5 detects both of voltage and current outputted to the load 10, the output detection unit 5 may include both circuits shown in FIG. 17 and FIG. 18. The configurations of the output detection unit shown in FIG. 17 and FIG. 18 are merely examples, and another configuration, e.g., a configuration using a transformer, may be adopted as long as at least one of voltage or current outputted to the load can be detected.

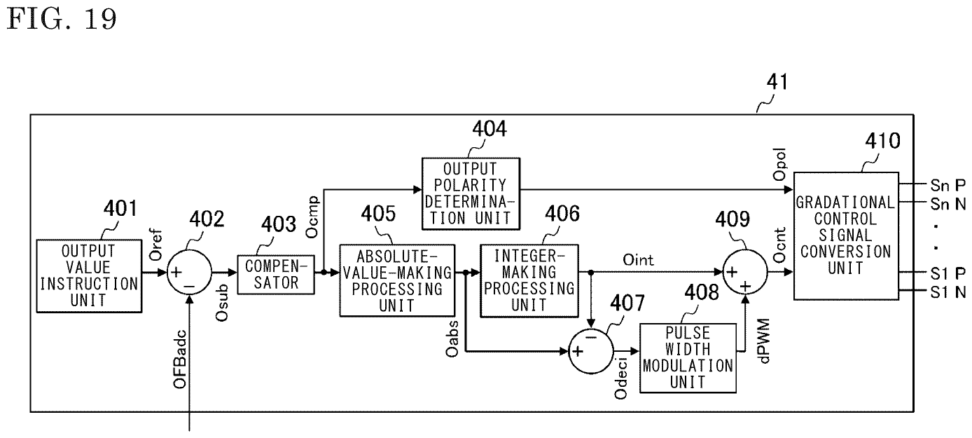

FIG. 19 is a configuration diagram of the gradational control signal generation unit of the power conversion device of the present embodiment. The gradational control signal generation unit 41 of the present embodiment includes an output value instruction unit 401, a first subtractor 402, a compensator 403, an output polarity determination unit 404, an absolute-value-making processing unit 405, an integer-making processing unit 406, a second subtractor 407, a pulse width modulation unit 408, an adder 409, and a gradational control signal conversion unit 410.

The output value instruction unit 401 outputs an output value instruction waveform Oref such as a sinewave. The first subtractor 402 outputs a differential signal Osub obtained by subtracting the negative-feedback signal OFBadc from the output value instruction waveform Oref. The compensator 403 outputs a compensated differential signal Ocmp obtained by compensating the differential signal Osub using proportional operation, integration operation, differentiation operation, or the like. The output polarity determination unit 404 outputs an output polarity instruction signal Opol that determines a positive or negative polarity of the whole output voltage Vsum from the compensated differential signal Ocmp. The absolute-value-making processing unit 405 outputs an absolute value signal Oabs obtained by making the compensated differential signal Ocmp into an absolute value. The integer making processing unit 406 outputs an integer signal Oint obtained by making the absolute value signal Oabs into an integer value. The second subtractor 407 outputs a decimal value signal Odeci obtained by subtracting the integer signal Oint from the absolute value signal Oabs. The pulse width modulation unit 408 performs pulse width modulation of the decimal value signal Odeci with a carrier frequency, to generate a decimal part PWM signal dPMW, and outputs the decimal part PWM signal dPMW. The adder 409 outputs an output voltage control signal Ocnt obtained by adding the decimal part PWM signal dPMW to the integer signal Oint. The gradational control signal conversion unit 410 outputs the gradational control signals SmN and SmP (m=1, 2, . . . , n) for performing switching control for the switching elements of each single-phase inverter, on the basis of the output polarity instruction signal Opol and the output voltage control signal Ocnt.

In a case where a target to be outputted to the load is a voltage waveform, the output value instruction waveform Oref is an output voltage command waveform. In a case where a target to be outputted to the load is a current waveform, the output value instruction waveform Oref is an output current instruction waveform. In a case where a target to be outputted to the load is a power waveform, the output value instruction waveform Oref may be both of an output voltage command waveform and an output current instruction waveform, or may be a power instruction waveform,

Operation of the power conversion device configured as described above will be described. Hereinafter, description will be given using the power conversion device formed by four single-phase inverters, as an example,

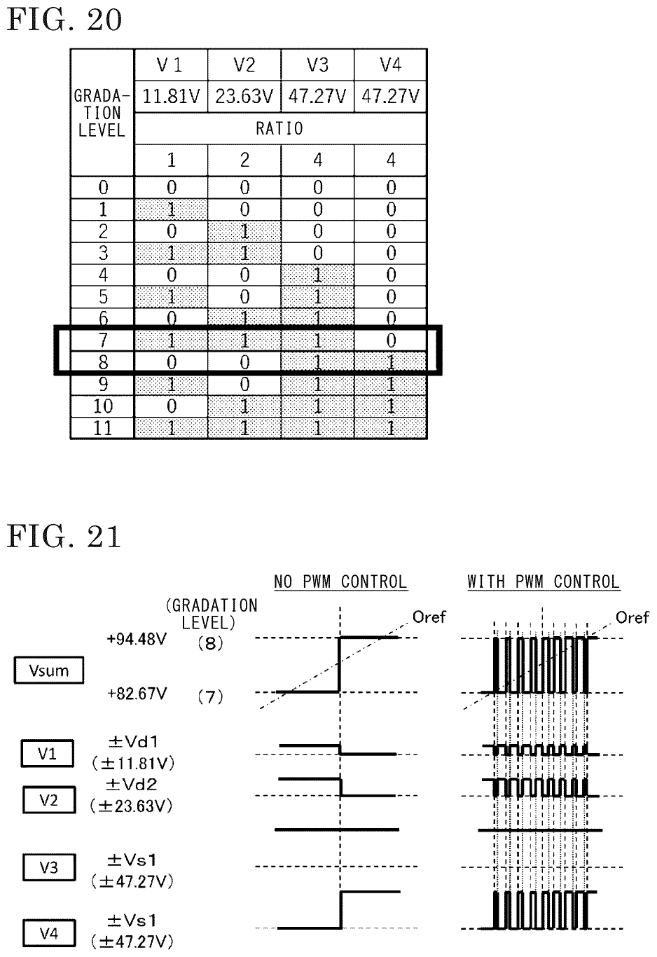

FIG. 20 is a table illustrating combinations of the voltage absolute values V1, V2, V3, and V4 of the four single-phase inverters for realizing outputs at gradation levels in the power conversion device of the present embodiment. In the power conversion device of the present embodiment, the ratio of the voltage absolute values V1, V2, V3, and V4 of the four single-phase inverters is 1:2:4:4. V1, V2, V3, and V4 are set so that the maximum voltage of the whole output voltage Vsum becomes ±130 V. Specifically, V1, V2, V3, and V4 are set as V1=11.81 V, V2=23.63 V, and V3=V4=47.27 V. That is, the voltage absolute values of two single-phase inverters among the four single-phase inverters are set at the same first common voltage Vs1=47.27 V. Here, operation of the power conversion device in a case of being instructed to perform output for the whole output voltage Vsum at a gradation level from 7 (+82.67 V) to 8 (+94.48 V), will be described.

FIG. 21 shows output voltage waveforms of the four single-phase inverters in a case of being instructed to perform output for the whole output voltage Vsum at a gradation level between 7 and 8. For comparison, output voltage waveforms in a case of not performing PWM control and a case of performing PWM control are shown. In FIG. 21, in a case of not performing PWM control, a gradation level of the whole output voltage Vsum between 7 and 8 cannot be expressed, and in this voltage section, the gradation level changes by one step between 7 and 8. On the other hand, in a case of performing PWM control, the combination of output states of the single-phase inverters can be switched between the output states V1=“1”, V2=“1”, V3=“1”, and V4=“0” at the gradation level 7 and the output states V1=“0”, V2=“0”, V3=“1”, and V4=“1” at the gradation level 8, in a cycle of the reciprocal of the carrier frequency. That is, three single-phase inverters that output V1, V2, and V4 are subjected to PWM control at the same time. As a result, voltage pulses of the whole output voltage Vsum are ON/OFF controlled so that the average value thereof comes close to voltage indicated by the output value instruction waveform Oref.

The number of necessary single-phase inverters that are subjected to PWM control at the same time in order to control Vsum as voltage pulses differs depending on gradation level numbers indicated by the output value instruction waveform Oref. For example, in FIG. 20, in a case of changing the whole output voltage Vsum as a binary voltage pulse between gradation levels 0 and 1, only one single-phase inverter that outputs V1 is subjected to PWM control. In a case of changing the whole output voltage Vsum as a binary voltage pulse between gradation levels 1 and 2, two single-phase inverters that output V1 and V2 are subjected to PWM control at the same time.

With the power conversion device configured as described above, it is possible to perform gradational control for the whole output voltage Vsum at a voltage resolution that is equivalently made smaller than 1 level by PWM control being added to gradational control.

### Embodiment 4

In the power conversion device in which PWM control is added to gradational control as described in embodiment 3, the voltage absolute values of at least two first common single-phase inverters among the three or more single-phase inverters 2 are set at the same first common voltage Vs1. Hereinafter, it is assumed that the power conversion device is formed by four single-phase inverters including two first common single-phase inverters, as an example. In this power conversion device, depending on the output waveform of the whole output voltage Vsum, there is a case where the number of times of switching in PWM control for one first common single-phase inverter increases while the number of times of Switching in PWM control for the other first common single-phase inverter decreases or the other first common single-phase inverter undergoes no switching. In this case, switching loss concentrates on the one first common single-phase inverter. The power conversion device of embodiment 4 performs control such that the numbers of times of switching in the two first common single-phase inverters set at the first common voltage Vs1 are almost equalized. The configuration of the power conversion device of the present embodiment is the same as the configuration of the power conversion device of embodiment 3.

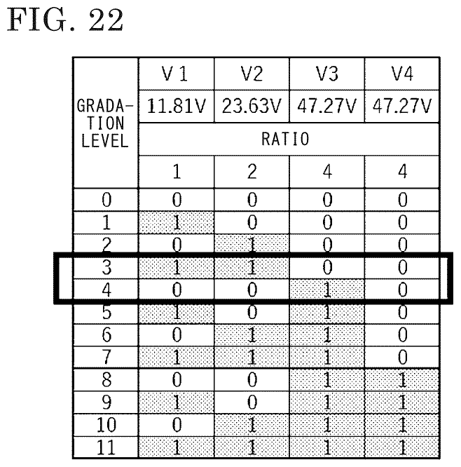

FIG. 22 is a table illustrating combinations of the voltage absolute values V1, V2, V3, and V4 of the four single-phase inverters for realizing outputs at gradation levels in the power conversion device of the present embodiment. In the power conversion device of the present embodiment, the ratio of the voltage absolute values V1, V2, V3, and V4 of the four single-phase inverters is 1:2:4:4, V1, V2, V3, and V4 are set so that the maximum voltage of the whole output voltage Vsum becomes ±130 V. Specifically, V1, V2, V3, and V4 are set as V1=11.81 V, V2=23.63 V, and V3=V4=47.27 V. Here, in a case of being instructed to perform output for the whole output voltage Vsum at a gradation level between 3 and 4, only the single-phase inverter that outputs V3 and which is the first common single-phase inverter performs output, and the single-phase inverter that outputs V4 and which is the first common single-phase inverter does not perform output. That is, only the single-phase inverter that outputs V3 performs switching operation by PWM control, and the single-phase inverter that outputs V4 does not perform switching operation by PWM control. The power conversion device of the present embodiment performs control so that switching operation concentrated on the one first common single-phase inverter is distributed to the other first common single-phase inverter. Hereinafter, such processing for distributing switching operation among a plurality of first common single-phase inverters is referred to as switching distribution processing.

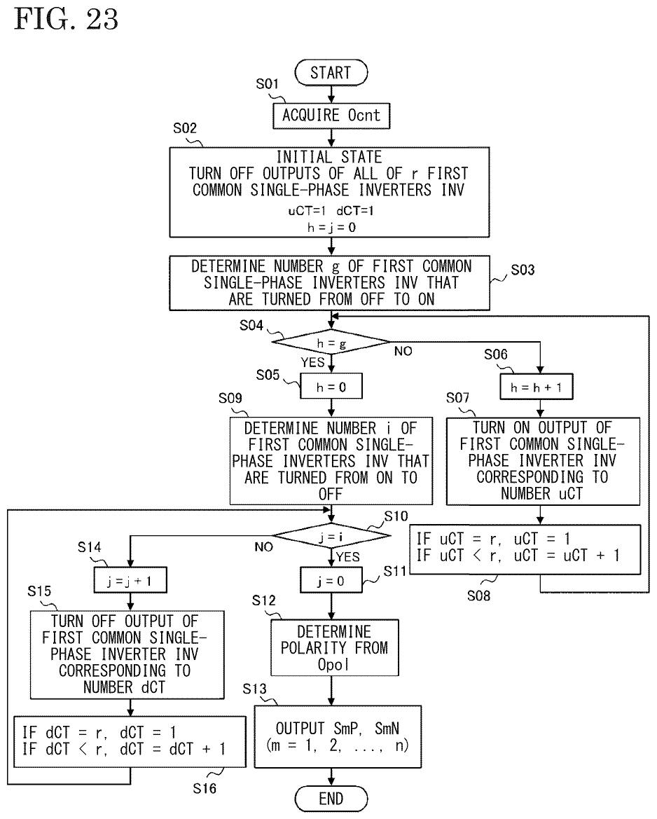

FIG. 23 is a flowchart showing a control method in the power conversion device of the present embodiment. The flowchart in FIG. 23 shows operation when the gradational control signal conversion unit 410 shown in FIG. 19 starts a process in a unit cycle. Exceptionally in the flowchart in FIG. 23, it is assumed that the power conversion device has first common single-phase inverters the number of which is r.

When the process is started, in step S01, the gradational control signal conversion unit 410 acquires an output voltage control signal Ocnt. Next, in step S02, the gradational control signal conversion unit 410 sets an initial state. In step S02, the gradational control signal conversion unit 410 sets the outputs of all the r first common single-phase inverters to OFF, and sets an up-control counter uCT for the first common single-phase inverters at 1, a down-control counter dCT for the first common single-phase inverters at 1, and parameters h and j at 0. The setting for the initial state in step S02 is performed only when the process in the first unit cycle is started, and the previous values are retained for the next control cycle.

Next, in step S03, the gradational control signal conversion unit 410 determines a number q of the first common single-phase inverters whose outputs are turned from OFF to ON, on the basis of the output voltage control signal Ocnt.

Next, in step S04, the gradational control signal conversion unit 410 determines whether or not h is equal to g. If it is determined that h is equal to g in step S04 (YES), the gradational control signal conversion unit 410 proceeds to step S05, to set h at 0. If it is determined that h is not equal to g in step S04 (NO), the gradational control signal conversion unit 410 proceeds to step S06, to add 1 to h, thus newly setting h.

In step S07 subsequent to step S06, the gradational control signal conversion unit 410 turns on the output of the first common single-phase inverter corresponding to the number uCT. Then, in step S08, if uCT is equal to r, the gradational control signal conversion unit 410 sets uCT at 1, and if uCT is smaller than r, the gradational control signal conversion unit 410 adds 1 to uCT, thus newly setting uCT. Next, the gradational control signal conversion unit 410 returns to step S04.

In step S09 subsequent to step S05, the gradational control signal conversion unit 410 determines a number i of the first common single-phase inverters whose outputs are turned from ON to OFF, on the basis of the output voltage control signal Ocnt. Next, in step S10, the gradational control signal conversion unit 410 determines whether or not i is equal to j. If it is determined that i is equal to j in step S10 (YES), the gradational control signal conversion unit 410 proceeds to step S11, to set j at 0. If it is determined that i is not equal to j in step S10 (NO), the gradational control signal conversion unit 410 proceeds to step S14, to add 1 to j, thus newly setting j.

In step S15 subsequent to step S14, the gradational control signal conversion unit 410 turns off the output of the first common single-phase inverter corresponding to the number dCT. Then, in step S16, if dCT is equal to r, the gradational control signal conversion unit 410 sets dCT at 1, and if dCT is smaller than r, the gradational control signal conversion unit 410 adds 1 to dCT, thus newly setting dCT. Next, the gradational control signal conversion unit 410 returns to step S10.

In step S12 subsequent to step S11, the gradational control signal conversion unit 410 determines the polarity of the gradational control signal on the basis of the output polarity instruction signal Opol. Next, in step S13, the gradational control signal conversion unit 410 outputs the gradational control signals SmN and SmP (m=1, 2, . . . , n)

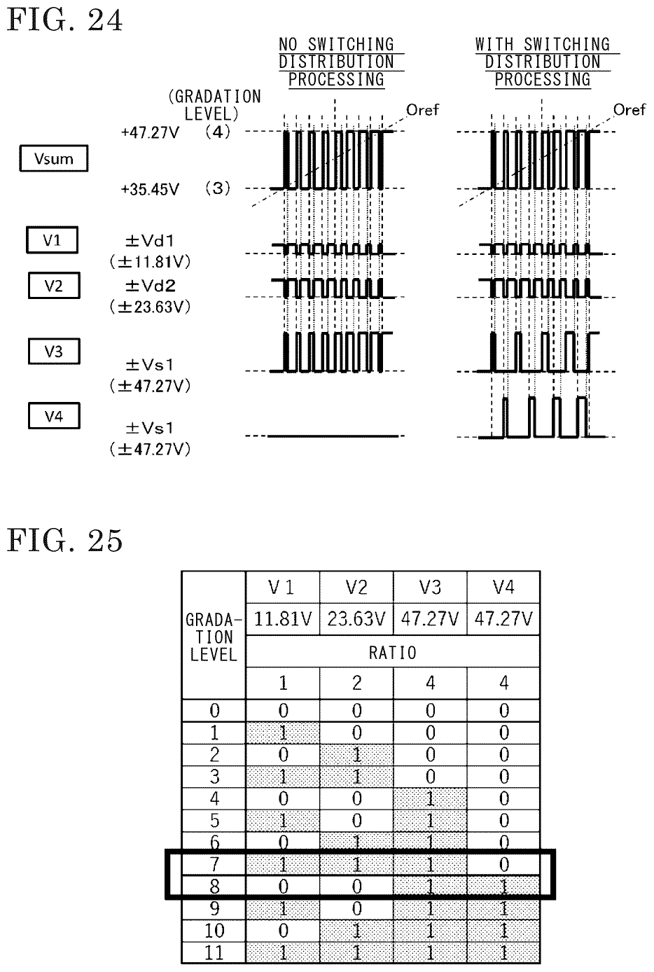

By the gradational control signal conversion unit 410 performing control as described above, it is possible to distribute switching operations among a plurality of first common single-phase inverters. FIG. 24 illustrates the switching distribution processing in the power conversion device formed by four single-phase inverters. FIG. 24 shows an example in which the whole output voltage Vsum is changed as binary voltage pulses between gradation levels 3 and 4 in the power conversion device formed by four single-phase inverters as shown in FIG. 22. In FIG. 24, a case of not performing the switching distribution processing is also shown together.

As shown in FIG. 22, the output states of the first common single-phase inverters that output V3 and V4 are V3=“0” and V4=“0” in a case where the gradation level is 3, and V3=“1” and V4=“0” in a case where the gradation level is 4. Therefore, in a case of switching the gradation level between 3 and 4, it is necessary to switch the output state of only the first common single-phase inverter that outputs V3. As shown in FIG. 24, in a case of not performing the switching distribution processing, the output of the first common single-phase inverter that outputs V3 changes in a cycle of the reciprocal of the carrier frequency, but the output of the first common single-phase inverter that outputs V4 does not change.

On the other hand, in a case of performing the switching distribution processing, output voltage pulses are generated such that output voltage pulses of the first common single-phase inverter that outputs V3 are alternately divided between the first common single-phase inverter that outputs V3 and the first common single-phase inverter that outputs V4. The waveform of the whole output voltage Vsum in the case of performing the switching distribution processing is the same as the waveform of the whole output voltage Vsum in the case of not performing the switching distribution processing. That is, in a case of switching the gradation level between 3 and 4 in the power conversion device of the present embodiment, the switching operation biased to the first common single-phase inverter that outputs V3 is equally distributed to the first common single-phase inverters that output V3 and V4, through the switching distribution processing. In the period in which the whole output voltage Vsum is changed as binary voltage pulses between the gradation levels 3 and 4, the number of times of switching in the single-phase inverter that outputs V3 under the switching distribution processing is almost halved as compared to the case of not performing the switching distribution processing. Thus, it is possible to prevent switching loss from concentrating on one first common single-phase inverter.

Effects by performing the switching distribution processing in the power conversion device of the present embodiment will be further described.

FIG. 25 is a table illustrating combinations of the voltage absolute values V1, V2, V3, and V4 of the four single-phase inverters for realizing outputs at gradation levels in the power conversion device of the present embodiment. In the power conversion device of the present embodiment, the ratio of the voltage absolute values V1, V2, V3, and V4 of the four single-phase inverters is 1:2:4:4. V1, V2, V3, and V4 are set so that the maximum voltage of the whole output voltage Vsum becomes ±130 V. Specifically, V1, V2, V3, and V4 are set as V1=11.81 V, V2=23.63 V, and V3=V4=47.27 V.

As shown in FIG. 25, the output states of the first common single-phase inverters that output V3 and V4 are V3=“1” and V4=“0” in a case where the gradation level is 7, and V3=“1” and V4=“1” in a case where the gradation level is 8. Therefore, in a case of switching the gradation level between 7 and 8, it is necessary to switch the output state of only the first common single-phase inverter that outputs V4.

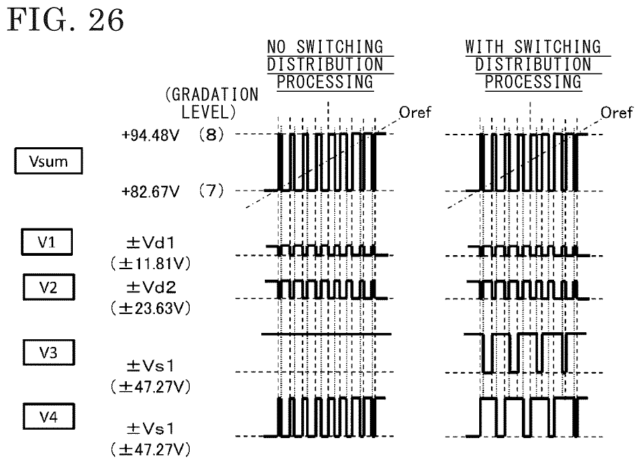

FIG. 26 illustrates the switching distribution processing in the power conversion device formed by four single-phase inverters. FIG. 26 shows an example in which the whole output voltage Vsum is changed as binary voltage pulses at gradation levels 7 and 8 in the power conversion device formed by four single-phase inverters as shown in FIG. 25. In FIG. 26, a case of not performing the switching distribution processing is also shown together. As shown in FIG. 26, in a case of not performing the switching distribution processing, the output of the first common single-phase inverter that outputs V3 is constant and does not change, but the output of the first common single-phase inverter that outputs V4 changes in a cycle of the reciprocal of the carrier frequency.

On the other hand, in a case of performing the switching distribution processing, output voltage pulses are generated such that output voltage pulses of the first common single-phase inverter that outputs V4 are alternately divided between the first common single-phase inverter that outputs V3 and the first common single-phase inverter that outputs V4, while becoming voltage pulses having greater pulse widths. The waveform of the whole output voltage Vsum in the case of performing the switching distribution processing is the same as the waveform of the whole output voltage Vsum in the case of not performing the switching distribution processing. That is, in a case of switching the gradation level between 7 and 8 in the power conversion device of the present embodiment, the switching operation biased to the first common single-phase inverter that outputs V4 is equally distributed to the first common single-phase inverters that output V3 and V4, through the switching distribution processing. In the period in which the whole output voltage Vsum is changed as binary voltage pulses between the gradation levels 7 and 8, the number of times of switching in the single-phase inverter that outputs V4 under the switching distribution processing is almost halved as compared to the case of not performing switching distribution processing. Thus, it is possible to prevent switching loss from concentrating on one first common single-phase inverter.

As described above, in the power conversion device of the present embodiment, the first common single-phase inverters each include one or more switching elements, and the control unit minimizes the difference between the numbers of times of switching of the switching elements respectively included in two or more first common single-phase inverters per unit time. Thus, it is possible to prevent switching loss from concentrating on a specific first common single-phase inverter.

In the power conversion device of the present embodiment, in a case where the output value instruction waveform Oref is a sinewave, the numbers of times of switching in the first common single-phase inverters in one cycle can be equalized through the switching distribution processing.

The switching distribution processing in the present embodiment has been described with the waveform in the case of applying the switching distribution processing to the power conversion device that uses PWM control as described in embodiment 3. The switching distribution processing in the present embodiment may be applied to the power conversion device that does not use PWM control. For example, in a case of a power conversion device in which the output value instruction waveform Oref is a ramp waveform having a DC offset so that the gradation level is repeatedly switched between 7 and 8, the switching distribution processing of the present embodiment can be applied.

In the present embodiment, the effects of the switching distribution processing have been described using the power conversion device having two first common single-phase inverters. As shown in the flowchart in FIG. 23, the switching distribution processing in the present embodiment can be applied to a power conversion device having three or more first common single-phase inverters.

As described above, with the power conversion device of the present embodiment, the number of times of switching can be distributed among a plurality of first common single-phase inverters, whereby it is possible to prevent switching loss from concentrating on one first common single-phase inverter. As a result, the power conversion device of the present embodiment makes it possible to use a small-sized heat dissipater, for example, whereby size increase and cost increase can be suppressed.

### Embodiment 5

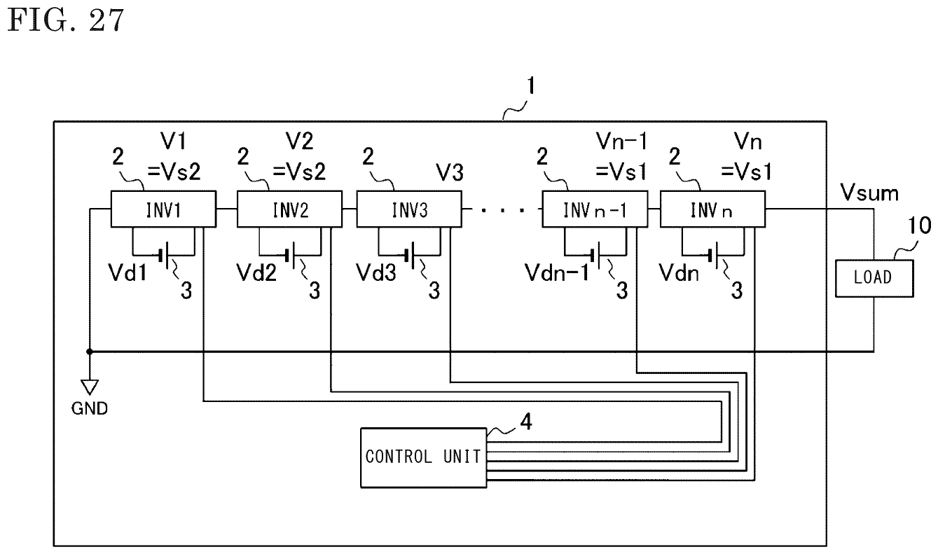

FIG. 27 is a configuration diagram of a power conversion device according to embodiment 5. The configuration of the power conversion device 1 of the present embodiment is the same as the configuration of the power conversion device shown in FIG. 1 in embodiment 1. In the power conversion device 1 of the present embodiment, the voltage absolute values of two single-phase inverters among four or more single-phase inverters 2 are set at the same first common voltage Vs1, and the voltage absolute values of the other two single-phase inverters are set at the same second common voltage Vs2. The first common voltage Vs1 is set to be greater than the smallest value of the voltage absolute values V1, V2, V3, . . . Vn−2 of the single-phase inverters. The second common voltage Vs2 is set to be smaller than the first common voltage Vs1. In the power conversion device 1 shown in FIG. 27, the voltage absolute value Vn−1 of the single-phase inverter for INVn−1 and the voltage absolute value Vn of the single-phase inverter for INVn are set at the same Vs1. The voltage absolute value V1 of the single-phase inverter for INV1 and the voltage absolute value V2 of the single-phase inverter for INV2 are set at the same Vs2. The single-phase inverters of which the voltage absolute values are set at the first common voltage are referred to as first common single-phase inverters, and the single-phase inverters of which the voltage absolute values are set at the second common voltage are referred to as second common single-phase inverters.

Hereinafter, a control method in the power conversion device of the present embodiment will be described. For facilitating description, the power conversion device formed by four single-phase inverters will be described as an example.

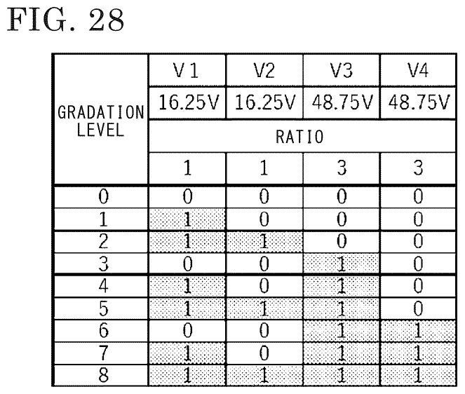

FIG. 28 is a table illustrating combinations of the voltage absolute values V1, V2, V3, and V4 of the four single-phase inverters for realizing outputs at gradation levels in the power conversion device of the present embodiment. In the power conversion device of the present embodiment, the ratio of the voltage absolute values V1, V2, V3, and V4 of the four single-phase inverters is 1:1:3:3. V1, V2, V3, and V4 are set so that the maximum voltage of the whole output voltage Vsum becomes ±130 V. Specifically, V1, V2, V3, and V4 are set as V1=V2=16.25 V, and V3=V4=48.75 V. That is, the voltage absolute values of two single-phase inverters among the four single-phase inverters are set at the same first common voltage Vs1=48.75 V, and the voltage absolute values of the other two single-phase inverters are set at the same second common voltage Vs2=16.25 V. With respect to the smallest ratio 1 among the voltage absolute values, the ratio of the first common voltage is defined as J, and the sum of the ratios of the voltage absolute values smaller than the ratio J is defined as K. Then, in the present embodiment, J=K+1 is satisfied.

In the power conversion device of the comparative example shown in FIG. 7 in embodiment 1, the output voltage of the single-phase inverter of which the voltage absolute value is greatest is 69.33 V. On the other hand, in the power conversion device of the present embodiment, the output voltage of the single-phase inverter of which the voltage absolute value is greatest is 48.75 V. Therefore, in the power conversion device of the present embodiment, as in the power conversion device of embodiment 1, MOSFET switching elements having lower withstand voltages than those in the power conversion device of the comparative example can be used. In addition, in the power conversion device of the present embodiment, as in the power conversion device of embodiment 1, switching loss in the single-phase inverters that output the voltage absolute values V3 and V4 can be reduced.

In the above description, the power conversion device of the present embodiment has been described as a power conversion device formed by four single-phase inverters. However, the power conversion device of the present embodiment may be formed by four or more single-phase inverters. Hereinafter, the characteristics of the power conversion device of the present embodiment formed by five single-phase inverters will be described. For comparison, the characteristics of a power conversion device of a comparative example in which the absolute values of output voltages of a plurality of single-phase inverters are respectively multiplied by approximately 2^{K} (K=0, 1, 2, . . . ) will also be described together.

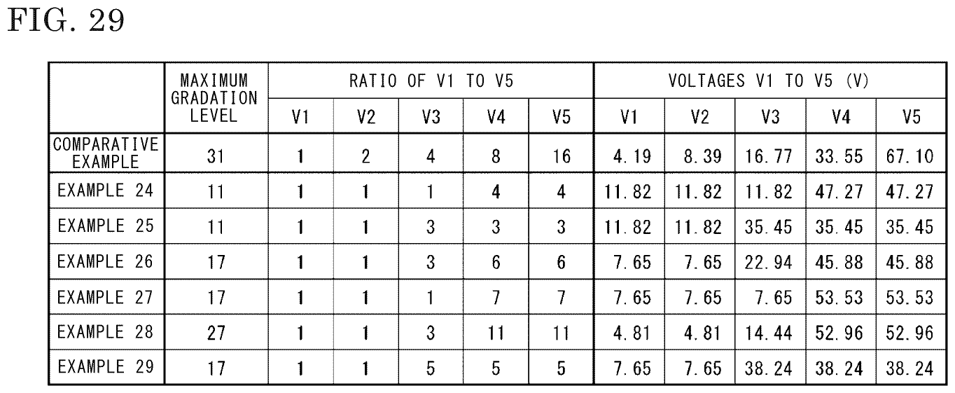

FIG. 29 is a table illustrating voltage configurations of the power conversion device of the present embodiment formed by five single-phase inverters. The table in FIG. 29 shows the voltage ratio of V1 to V5 and voltages of V1 to V5. The voltages of V1 to V5 are set so that the whole output voltage Vsum becomes ±130 V. As shown in FIG. 29, in the power conversion device of the comparative example, the voltage ratio is set as V1:V2:V3:V4:V5=1:2:4:8:16.

As the power conversion device of the present embodiment, the power conversion devices of Examples 24 to 29 are formed by five single-phase inverters. In the power conversion device of Example 24, the voltage ratio is set as V1:V2:V3:V4:V5=1:1:1:4:4. In the power conversion device of Example 25, the voltage ratio is set as V1:V2:V3:V4:V5=1:1:3:3:3. In the power conversion device of Example 26, the voltage ratio is set as V1:V2:V3:V4:V5=1:1:3:6:6. In the power conversion device of Example 27, the voltage ratio is set as V1:V2:V3:V4:V5=1:1:1:7:7. In the power conversion device of Example 28, the voltage ratio is set as V1:V2:V3:V4:V5=1:1:3:11:11. In the power conversion device of Example 29, the voltage ratio is set as V1:V2:V3:V4:V5=1:1:5:5:5. In the power conversion devices of Examples 24 to 29, the first common voltage is set at the greatest value among the voltage absolute values, and the second common voltage is set at the smallest value among the voltage absolute values.

The greatest voltages of the single-phase inverters in the power conversion devices of Examples 24 to 29 shown in FIG. 29 are smaller than the greatest voltage of the single-phase inverters in the power conversion device of the comparative example. Therefore, in the power conversion devices of Examples 24 to 29, MOSFET switching elements having lower withstand voltages than those in the power conversion device of the comparative example can be used,

Here, with respect to the smallest ratio 1 among the voltage absolute values, the ratio of the first common voltage is defined as J, and the sum of the ratios of the voltage absolute values smaller than the ratio J is defined as K. In the power conversion devices of Examples 24 to 26, J=K+1 is satisfied. In the power conversion device of Examples 27 to 29, J=2K+1 is satisfied.

In the power conversion devices of Examples 24 to 29 shown in FIG. 29, the second common voltage is set at the smallest value of the voltage absolute values. In the power conversion device of the present embodiment, the second common voltage may not necessarily be the smallest value of the voltage absolute values.

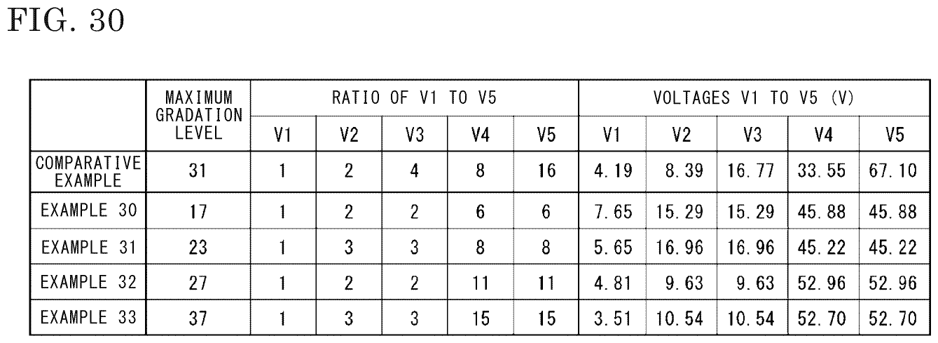

FIG. 30 is a table illustrating voltage configurations of the power conversion device of the present embodiment formed by five single-phase inverters. The table in FIG. 30 shows the voltage ratio of V1 to V5 and voltages of V1 to V5. The voltages of V1 to V5 are set so that the whole output voltage Vsum becomes ±130 V. As shown in FIG. 30, in the power conversion device of the comparative example, the voltage ratio is set as V1:V2:V3:V4:V5=1:2:4:8:16.

As the power conversion device of the present embodiment, power conversion devices of Examples 30 to 33 are formed by five single-phase inverters. In the power conversion device of Example 30, the voltage ratio is set as V1:V2:V3:V4:V5=1:2:2:6:6. In the power conversion device of Example 31, the voltage ratio is set as V1:V2:V3:V4:V5=1:3:3:8:8. In the power conversion device of Example 32, the voltage ratio is set as V1:V2:V3:V4:V5=1:2:2:11:11. In the power conversion device of Example 33, the voltage ratio is set as V1:V2:V3:V4:V5=1:3:3:15:15. In the power conversion devices of Examples 30 to 33, the first common voltage is set at the greatest value of the voltage absolute values, and the second common voltage is set at a voltage value that is not smallest among the voltage absolute values.

The greatest voltages of the single-phase inverters in the power conversion devices of Examples 30 to 33 shown in FIG. 30 are smaller than the greatest voltage of the single-phase inverters in the power conversion device of the comparative example. Therefore, in the power conversion device of Examples 30 to 33, MOSFET switching elements having lower withstand voltages than those in the power conversion device of the comparative example can be used.

Here, with respect to the smallest ratio 1 among the voltage absolute values, the ratio of the first common voltage is defined as J, and the sum of the ratios of the voltage absolute values smaller than the ratio J is defined as K. In the power conversion devices of Examples 30 and 31, J=K+1 is satisfied. In the power conversion device of Examples 32 and 33, J=2K+1 is satisfied.

### Embodiment 6

A power conversion device of embodiment 6 is configured such that, in the power conversion device in which PWM control is added to gradational control as described in embodiment 3, the voltage absolute values of at least two first common single-phase inverters among the plurality of single-phase inverters 2 are set at the same first common voltage Vs1, and the voltage absolute values of at least two second common single-phase inverters among the other single-phase inverters 2 are set at the same second common voltage Vs2. Hereinafter, it is assumed that the power conversion device is formed by four single-phase inverters including two first common single-phase inverters and two second common single-phase inverters, as an example. In this power conversion device, depending on the output waveform of the whole output voltage Vsum, there is a case where the number of times of switching in PWM control for one second common single-phase inverter increases while the number of times of switching in PWM control for the other second common single-phase inverter decreases or the other second common single-phase inverter undergoes no switching. In this case, switching loss concentrates on the one second common single-phase inverter. The power conversion device of the present embodiment performs control such that the numbers of times of switching in the two second common single-phase inverters set at the second common voltage Vs2 are almost equalized.

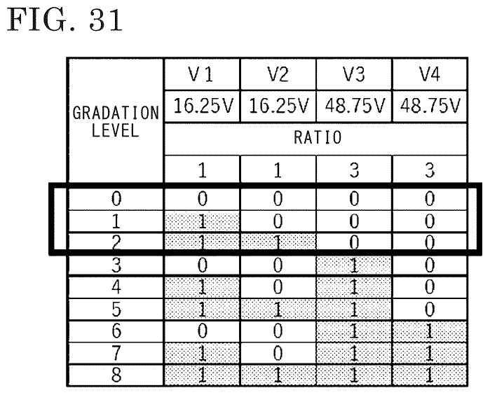

FIG. 31 is a table illustrating combinations of the voltage absolute values V1, V2, V3, and V4 of the four single-phase inverters for realizing outputs at gradation levels in the power conversion device of the present embodiment. In the power conversion device of the present embodiment, the ratio of the voltage absolute values V1, V2, V3, and V4 of the four single-phase inverters is 1:1:3:3. V1, V2, V3, and V4 are set so that the maximum voltage of the whole output voltage Vsum becomes ±130 V. Specifically, V1, V2, V3, and V4 are set as V1=V2=16.25 V, and V3=V4=48.75 V. Here, a case of being instructed to perform output for the whole output voltage Vsum at a gradation level from 0 to 1, and a case of being instructed to perform output for the whole output voltage Vsum at a gradation level from 1 to 2, will be described as an example.

In a case of being instructed to perform output for the whole output voltage Vsum at a gradation level from 0 to 1, only the single-phase inverter that outputs V1 and which is the second common single-phase inverter performs output, and the single-phase inverter that outputs V2 and which is the second common single-phase inverter does not perform output. That is, only the single-phase inverter that outputs V1 performs switching operation by PWM control, and the single-phase inverter that outputs V2 does not perform switching operation by PWM control.

In the case of being instructed to perform output for the whole output voltage Vsum at a gradation level from 1 to 2, as shown in FIG. 31, the output states of the second common single-phase inverters that output V1 and V2 are V1=“1” and V2=“0” in a case where the gradation level is 1, and V1=“1” and V2=“1” in a case where the gradation level is 2. Therefore, in a case of switching the gradation level between 1 and 2, it is necessary to switch the output state of only the second common single-phase inverter that outputs V2. The power conversion device of the present embodiment performs control so that switching operation concentrated on one second common single-phase inverter is distributed to the other second common single-phase inverter.

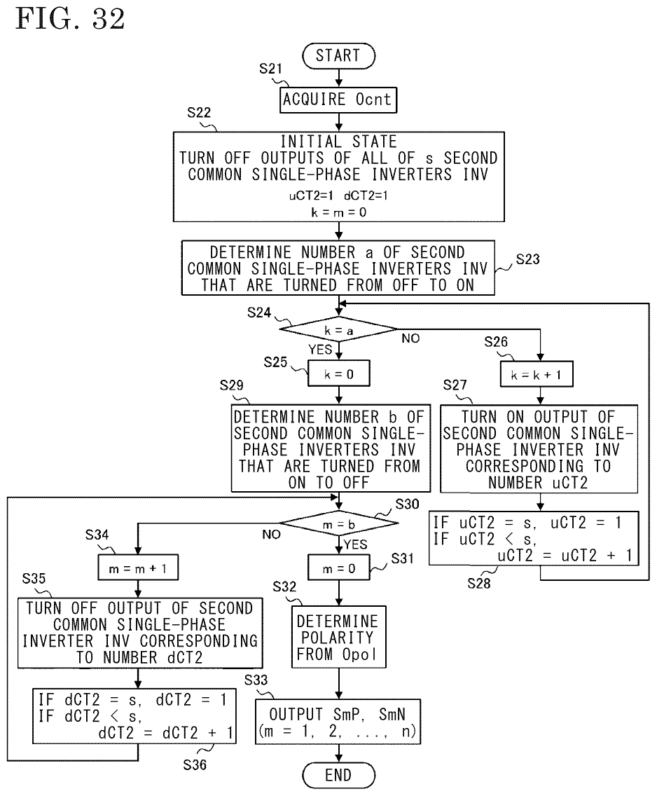

FIG. 32 is a flowchart showing a control method in the power conversion device of the present embodiment. The flowchart in FIG. 32 shows operation when the gradational control signal conversion unit 410 starts a process in a unit cycle. Exceptionally in the flowchart in FIG. 32, it is assumed that the power conversion device has second common single-phase inverters the number of which is s.

When the process is started, in step S21, the gradational control signal conversion unit 410 acquires an output voltage control signal Ont. Next, in step S22, the gradational control signal conversion unit 410 sets an initial state. In step S22, the gradational control signal conversion unit 410 sets the outputs of all the s second common single-phase inverters to OFF, and sets an up-control counter uCT2 for the second common single-phase inverters at 1, a down-control counter dCT2 for the second common single-phase inverters at 1, and parameters k and m at 0. The setting for the initial state in step S22 is performed only when the process in the first unit cycle is started, and the previous values are retained for the next control cycle.

Next, in step S23, the gradational control signal conversion unit 410 determines a number a of the second common single-phase inverters whose outputs are turned from OFF to ON, on the basis of the output voltage control signal Ocnt. Next, in step S24, the gradational control signal conversion unit 410 determines whether or not k is equal to a. If it is determined that k is equal to a in step S24 (YES), the gradational control signal conversion unit 410 proceeds to step S25, to set k at 0. If it is determined that k is not equal to a in step S24 (NO), the gradational control signal conversion unit 410 proceeds to step S26, to add 1 to k, thus newly setting k.

In step S27 subsequent to step S26, the gradational control signal conversion unit 410 turns on the output of the second common single-phase inverter corresponding to the number uCT2. Then, in step S28, if uCT2 is equal to s, the gradational control signal conversion unit 410 sets uCT2 at 1, and if uCT2 is smaller than s, the gradational control signal conversion unit 410 adds 1 to uCT2, thus newly setting uCT2. Next, the gradational control signal conversion unit 410 returns to step S24.

In step S29 subsequent to step S25, the gradational control signal conversion unit 410 determines a number b of the second common single-phase inverters whose outputs are turned from ON to OFF, on the basis of the output voltage control signal Ocnt. Next, in step S30, the gradational control signal conversion unit 410 determines whether or not m is equal to b. If it is determined that m is equal to b in step S30 (YES), the gradational control signal conversion unit 410 proceeds to step S31, to set m at 0, If it is determined that m is not equal to b in step S30 (NO), the gradational control signal conversion unit 410 proceeds to step S34, to add 1 to m, thus newly setting m.

In step S35 subsequent to step S34, the gradational control signal conversion unit 410 turns off the output of the second common single-phase inverter corresponding to the number dCT2. Then, in step S36, if dCT2 is equal to s, the gradational control signal conversion unit 410 sets dCT2 at 1, and if dCT2 is smaller than s, the gradational control signal conversion unit 410 adds 1 to dCT2, thus newly setting dCT2. Next, the gradational control signal conversion unit 410 returns to step S30.

In step S32 subsequent to step S31, the gradational control signal conversion unit 410 determines the polarity of the gradational control signal on the basis of the output polarity instruction signal Opol. Next, in step S33, the gradational control signal conversion unit 410 outputs the gradational control signals SmN and SmP (m=1, 2, . . . , n).

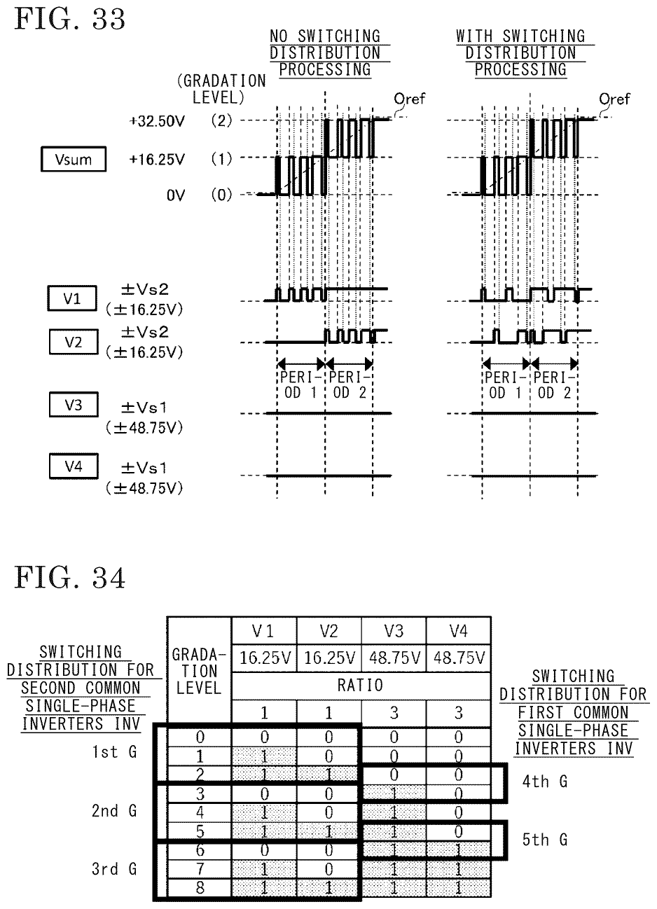

By the gradational control signal conversion unit 410 performing control as described above, it is possible to distribute switching operations among a plurality of second common single-phase inverters. FIG. 33 illustrates the switching distribution processing in the power conversion device formed by four single-phase inverters. FIG. 33 shows an example in which the whole output voltage Vsum is changed from a gradation level 0 to a gradation level 2 in the power conversion device formed by four single-phase inverters as shown in FIG. 31. In the example shown in FIG. 33, the whole output voltage Vsum is changed as binary voltage pulses from a gradation level 0 to a gradation level 1 during a period 1 and then from the gradation level 1 to a gradation level 2 during a period 2. In FIG. 33, a case of not performing the switching distribution processing is also shown together.

As shown in FIG. 31, the output states of the second common single-phase inverters that output V1 and V2 are V1=“0” and V2=“0” in a case where the gradation level is 0, V1=“1” and V2=“0” in a case where the gradation level is 1, and V1=“1” and V2=“1” in a case where the gradation level is 2. Therefore, in a case of switching the gradation level between 0 and 1, it is necessary to switch the output state of only the second common single-phase inverter that outputs V1. In addition, in a case of switching the gradation level between 1 and 2, it is necessary to switch the output state of only the second common single-phase inverter that outputs V2, while the output state of the second common single-phase inverter that outputs V1 is not changed.

As shown in FIG. 33, during the period 1, in the case of not performing the switching distribution processing, the output of the second common single-phase inverter that outputs V1 changes in a cycle of the reciprocal of the carrier frequency, but the second common single-phase inverter that outputs V2 does not perform output.

On the other hand, during the period 1, in the case of performing the switching distribution processing, output voltage pulses are generated such that output voltage pulses of the second common single-phase inverter that outputs V1 are alternately divided between the second common single-phase inverter that outputs V1 and the second common single-phase inverter that outputs V2. The waveform of the whole output voltage Vsum in the case of performing the switching distribution processing is the same as the waveform of the whole output voltage Vsum in the case of not performing the switching distribution processing. That is, in a case of switching the gradation level between 0 and 1 in the power conversion device of the present embodiment, the switching operation biased to the second common single-phase inverter that outputs V1 is equally distributed to the second common single-phase inverters that output V1 and V2, through the switching distribution processing. In the period 1, the number of times of switching in the single-phase inverter that outputs V1 under the switching distribution processing is almost halved as compared to the case of not performing the switching distribution processing. Thus, it is possible to prevent switching loss from concentrating on one second common single-phase inverter.

As shown in FIG. 33, during a period 2, in the case of not performing the switching distribution processing, the output of the second common single-phase inverter that outputs V1 is constant, and the output of the second common single-phase inverter that outputs V2 changes in a cycle of the reciprocal of the carrier frequency.

On the other hand, during the period 2, in a case of performing the switching distribution processing, output voltage pulses are generated such that output voltage pulses of the second common single-phase inverter that outputs V2 are alternately divided between the second common single-phase inverter that outputs V1 and the second common single-phase inverter that outputs V2, while becoming voltage pulses having greater pulse widths. The waveform of the whole output voltage Vsum in the case of performing the switching distribution processing is the same as the waveform of the whole output voltage Vsum in the case of not performing the switching distribution processing. That is, in a case of switching the gradation level between 1 and 2 in the power conversion device of the present embodiment, the switching operation biased to the second common single-phase inverter that outputs V2 is equally distributed to the second common single-phase inverters that output V1 and V2, through the switching distribution processing. In the period 2, the number of times of switching in the single-phase inverter that outputs V2 under the switching distribution processing is almost halved as compared to the case of not performing the switching distribution processing. Thus, it is possible to prevent switching loss from concentrating on one second common single-phase inverter.

As described above, in the power conversion device of the present embodiment, the second common single-phase inverters each include one or more switching elements, and the control unit minimizes the difference between the numbers of times of switching of the switching elements included in two or more second common single-phase inverters per unit time. Thus, it is possible to prevent switching loss from concentrating on a specific second common single-phase inverter.

In the power conversion device of the present embodiment, in a case where the output value instruction waveform Oref is a sinewave, the numbers of times of switching in the first common single-phase inverters in one cycle can be equalized through the switching distribution processing.

The switching distribution processing in the present embodiment has been described with the waveform in the case of applying the switching distribution processing to the power conversion device that uses PWM control as described in embodiment 3. The switching distribution processing in the present embodiment may be applied to the power conversion device that does not use PWM control. For example, in a case of a power conversion device in which the output value instruction waveform Oref is a ramp waveform so that the gradation level is repeatedly switched between 0 and 1 or 1 and 2, the switching distribution processing of the present embodiment can be applied.

In the present embodiment, the effects of the switching distribution processing have been described using the power conversion device having two second common single-phase inverters. As shown in the flowchart in FIG. 32, the switching distribution processing in the present embodiment can be applied to a power conversion device having three or more second common single-phase inverters.

In the power conversion device of the present embodiment, the distribution processing for the numbers of times of switching among the second common single-phase inverters has been performed in the case of switching the gradation level from 0 to 1 and the case of switching the gradation level from 1 to 2. The switching distribution processing may be applied also in a case of switching between other gradation levels. That is, the switching distribution processing can be applied in a case where there are a second Common single-phase inverter that needs to perform switching operation and a second common single-phase inverter that need not perform switching operation among the plurality of second common single-phase inverters, in switchover of the gradation levels.

FIG. 34 is a table illustrating combinations of the voltage absolute values V1, V2, V3, and V4 of the four single-phase inverters for realizing outputs at gradation levels in the power conversion device of the present embodiment. In the power conversion device of the present embodiment, the ratio of the voltage absolute values V1, V2, V3, and V4 of the four single-phase inverters is the same as that in FIG. 31.

A first group (1st G) shown in FIG. 34 is a case where the gradation level is changed between 0 and 1 or a case where the gradation level is changed between 1 and 2, as shown in FIG. 31 in the present embodiment, and therefore the switching distribution processing can be applied for the second common single-phase inverters. A second group (2nd G) shown in FIG. 34 is a case where the gradation level is changed between 3 and 4 or a case where the gradation level is changed between 4 and 5. In the second group, in the case where the gradation level is changed between 3 and 4, it is necessary to switch the output state of only the second common single-phase inverter that outputs V1. In the case of Switching the gradation level between 4 and 5, the output state of the second common single-phase inverter that outputs V1 does not change, but it is necessary to switch the output state of only the second common single-phase inverter that outputs V2. Therefore, also in the second group, as in the first group, the switching distribution processing can be applied for the second common single-phase inverters. For the same reason, also in a third group (3rd G) shown in FIG. 34, as in the first group, the switching distribution processing can be applied for the second common single-phase inverters.

In the power conversion device of the present embodiment, the switching distribution processing can be applied also for the first common single-phase inverters. For example, a fourth group (4th G) shown in FIG. 34 is a case where the gradation level is changed between 2 and 3. In the fourth group, in the case where the gradation level is changed between 2 and 3, it is necessary to switch the output state of only the first common single-phase inverter that outputs V3. Therefore, in the fourth group, the switching distribution processing can be applied for the first common single-phase inverters. A fifth group (5th G) shown in FIG. 34 is a case where the gradation level is changed between 5 and 6. In the case where the gradation level is switched between 5 and 6, the output state of the first common single-phase inverter that outputs V3 does not change, but it is necessary to switch the output state of only the first common single-phase inverter that outputs V4. Therefore, also in the fifth group, as in the fourth group, the switching distribution processing can be applied for the first common single-phase inverters.

As described above, in the power conversion device including the first common single-phase inverters and the second common single-phase inverters, the switching distribution processing is applied for at least either the first common single-phase inverters or the second common single-phase inverters, whereby it is possible to prevent switching loss from concentrating on a specific single-phase inverter.

### Embodiment 7

In the gradational control signal generation unit of the power conversion device shown in FIG. 19 in embodiment 3, depending on the waveform shape of the output value instruction waveform Oref outputted from the output value instruction unit 401, a large number of times of switching might need to be performed in some of the first common single-phase inverters. In a power conversion device of embodiment 7, output voltages of the DC power supplies of the single-phase inverters are adjusted so that the number of times of switching of the switching element per unit time becomes minimum not greater than a threshold in at least one of the first common single-phase inverters in a state in which the ratios of the voltage absolute values of the single-phase inverters are maintained.

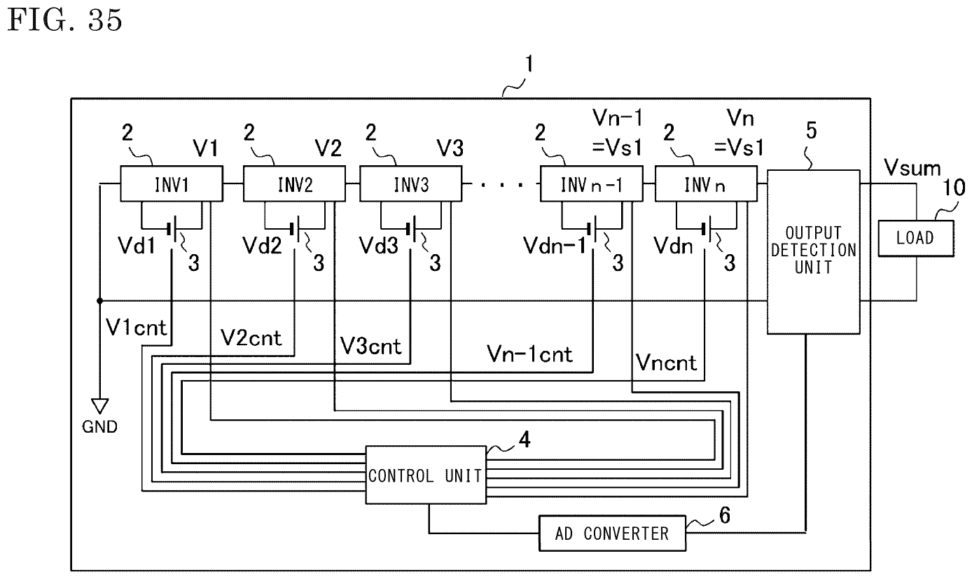

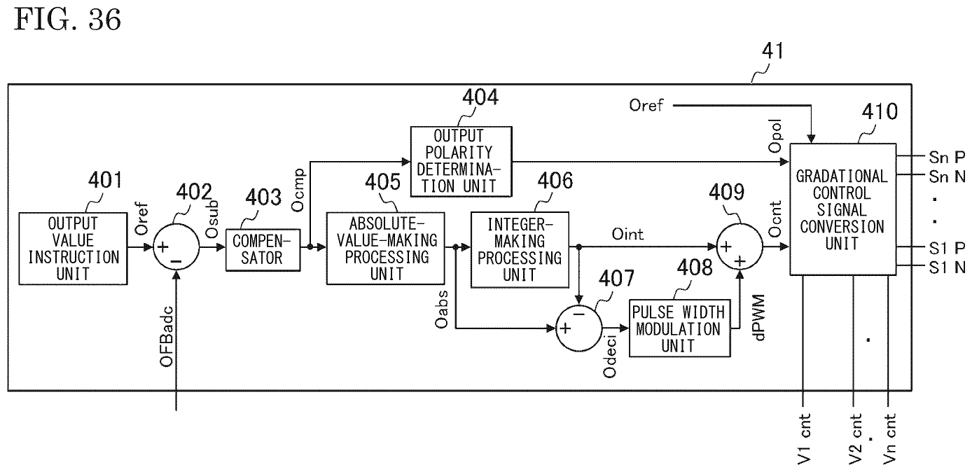

FIG. 35 is a configuration diagram of the power conversion device according to the present embodiment. FIG. 36 is a configuration diagram of the gradational control signal generation unit of the power conversion device according to the present embodiment. The gradational control signal generation unit 41 in the present embodiment is configured such that the output value instruction waveform Oref is added as a signal to be inputted to the gradational control signal conversion unit 410 in the gradational control signal generation unit shown in FIG. 19 in embodiment 3. Further, the gradational control signal conversion unit 410 outputs DC voltage control signals V1cnt, V2cnt, . . . , Vncnt which are target voltages for output voltages Vd1, Vd2, . . . , Vdn, to the plurality of DC power supplies 3.

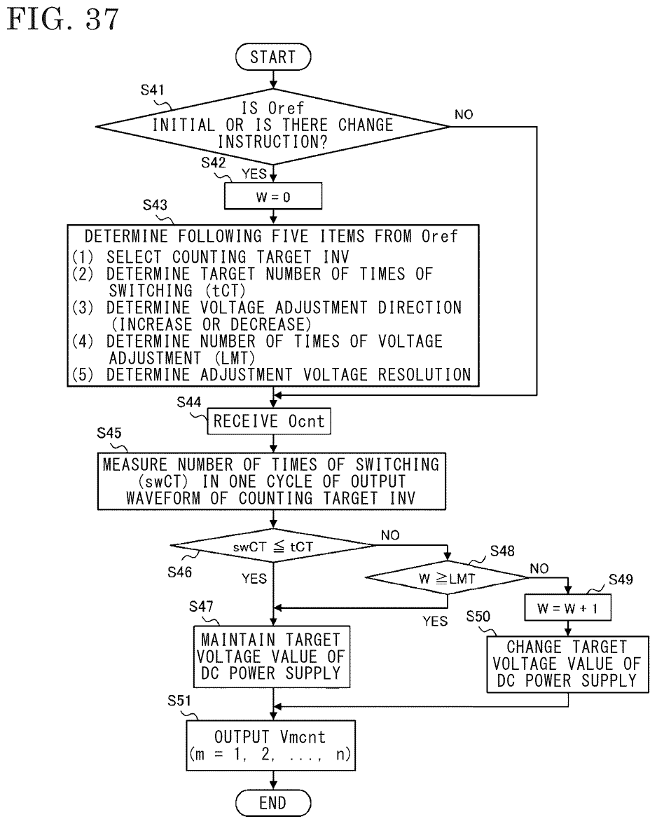

FIG. 37 is a flowchart showing a control method in the power conversion device according to the present embodiment. The flowchart in FIG. 37 shows operation when the gradational control signal conversion unit 410 starts process in a unit cycle. When the process is started, in step S41, the gradational control signal conversion unit 410 determines whether or not the inputted output value instruction waveform Oref is the initial one or there is a change instruction for the output value instruction waveform Oref. If it is determined that the output value instruction waveform Oref is the initial one or there is a change instruction for the output value instruction waveform Oref in step S41 (YES), the gradational control signal conversion unit 410 proceeds to step S42, to set W at 0. Next, in step S43, the gradational control signal conversion unit 410 determines the following five items on the basis of the output value instruction waveform Oref. As a first item, the first common single-phase inverter that is a target for which the number of times of switching is counted is selected. The selected single-phase inverter is referred to as a counting target inverter. As a second item, a target number of times of switching (tCT) is determined. As a third item, an adjustment direction for the output voltage of the DC power supply is determined. Here, the adjustment direction for the output voltage indicates whether to increase or decrease the voltage. As a fourth item, a number of times of adjustment (LMT) for the output voltage of the DC power supply is determined. As a fifth item, an adjustment voltage resolution for the maximum value of the whole output voltage Vsum is determined.

If it is determined that the output value instruction waveform Oref is not the initial one or there is no change instruction for the output value instruction waveform Oref in step S41 (NO), the gradational control signal conversion unit 410 proceeds to step S44. In step S44, the gradational control signal conversion unit 410 receives the output voltage control signal Ocnt. Next, in step S45, the gradational control signal conversion unit 410 measures a number of times of switching (swCT) in one cycle of the output voltage waveform of the counting target inverter selected in step S43. Next, in step S46, the gradational control signal conversion unit 410 determines whether or not swCT is equal to or smaller than tCT. If it is determined that swCT is equal to or smaller than tCT in step S46 (YES), the gradational control signal conversion unit 410 proceeds to step S47. In step S47, the gradational control signal conversion unit 410 maintains the target voltage for the DC power supply.

If it is determined that swCT is greater than tCT in step S46 (NO), the gradational control signal conversion unit 410 proceeds to step S48. In step S48, the gradational control signal conversion unit 410 determines whether or not W is equal to or greater than LMT. If it is determined that W is equal to or greater than LMT in step S48 (YES), the gradational control signal conversion unit 410 proceeds to step S47. If it is determined that W is smaller than LMT in step S48 (NO), the gradational control signal conversion unit 410 proceeds to step S49, to add 1 to W, thus newly setting W. Next, in step S50, the gradational control signal conversion unit 410 changes the target voltage for the DC power supply. Lastly, in step S51, the gradational control signal conversion unit 410 outputs the DC voltage control signals V1cnt, V2cnt, . . . , Vncnt which are the target voltages for the DC power supplies.

By the gradational control signal conversion unit 410 performing control as described above, the first common single-phase inverter that is a target for which the number of times of switching is counted is selected, and in a state in which the ratios of the voltage absolute values of the single-phase inverters are maintained, the output voltages for the DC power supplies can be adjusted so that the number of times of switching in the selected first common single-phase inverter becomes minimum or not greater than a threshold.

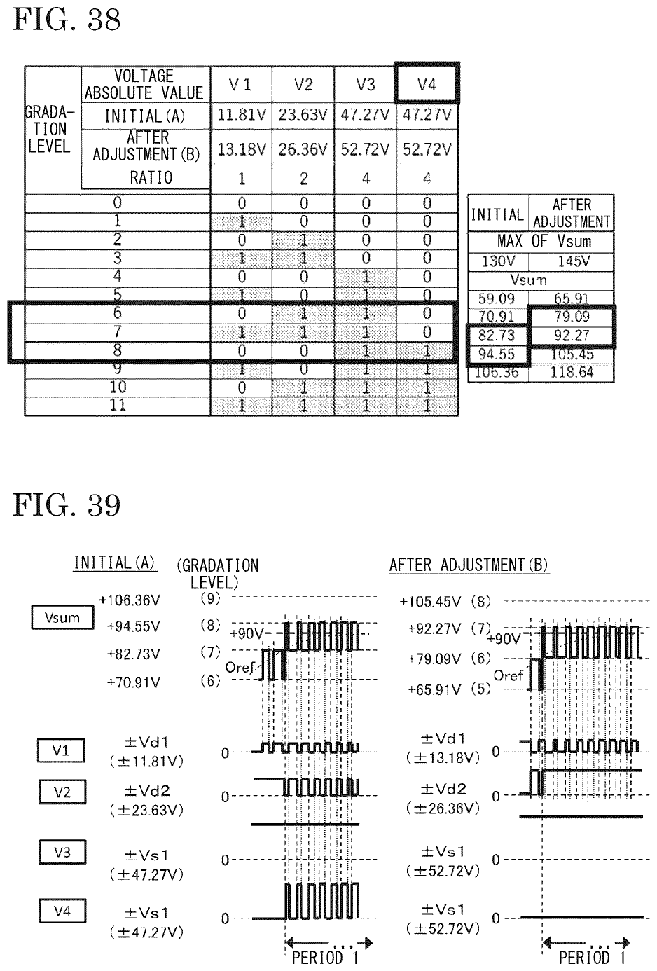

FIG. 38 illustrates voltage adjustment for the DC power supplies in the power conversion device formed by four single-phase inverters. In the power conversion device of the present embodiment, the ratio of the voltage absolute values V1, V2, V3, and V4 of the four single-phase inverters is 1:2:4:4. Therefore, the first common single-phase inverters are the single-phase inverters that output V3 and V4. In the initial state (A), V1, V2, V3, and V4 are set so that the maximum voltage of the whole output voltage Vsum becomes ±130 V. Specifically, V1, V2, V3, and V4 are set as V1=11.81 V, V2=23.63 V, and V3=V4=47.27 V.

In FIG. 38, a case where the output value instruction waveform Oref is a sinewave and the peak value thereof is ±90 V, is shown. It is noted that, although a sinewave is continuously outputted in a steady state, there is a case where output voltage of ±130 V is instantaneously indicated, depending on the load variation condition or the like. The first common single-phase inverter that is a target for which the number of times of switching is counted is only one single-phase inverter that outputs V4. The target number of times of switching of all the switching elements composing the single-phase inverter that outputs V4 in one cycle of the sinusoidal output value instruction waveform Oref, described above, is set at 0. The adjustment direction for the output voltage of the DC power supply is a direction to increase from the initial value. The number of times of adjustment (LMT) for the output voltage of each DC power supply is 10. If the number of times of switching cannot be made to be 0 which is the target number of times of switching through adjustment performed ten times or less, voltage adjustment for each DC power supply is finished and the voltages are maintained at the last adjusted values. In voltage adjustment of each DC power supply, an adjustment voltage resolution for the maximum value (in the initial state (A), 130 V) of the whole output voltage Vsum is 5 V.

As shown in FIG. 38, in the initial state (A), V1, V2, V3, and V4 are set as V1=11.81 V, V2=23.63 V, and V3=V4=47.27 V so that the whole output voltage Vsum becomes ±130 V. In a case where PWM control is performed in the power conversion device described in embodiment 3 and equivalent voltage of the whole output voltage Vsum is controlled to be +90 V which is a positive peak value of the sinewave in the initial state (A), PWM control is performed to form binary voltage pulses at the gradation level 7 (82.73 V) and the gradation level 8 (94.55 V).

FIG. 39 illustrates voltage adjustment for the DC power supplies in the power conversion device of the present embodiment. In the sinusoidal output value instruction waveform Oref described above, the details of a part where outputs around +90 V which is a positive peak value are indicated are shown. In FIG. 39, a period 1 is a period in which binary voltage pulses are outputted so that the whole output voltage Vsum can be outputted as equivalent voltage of +90 V in a case where the output value instruction waveform Oref indicates outputs around +90 V. In the initial state (A) in FIG. 39, the binary gradation level described above is between 7 and 8. After adjustment (B) in FIG. 39, the binary gradation level described above is between 6 and 7.

As shown in FIG. 39, in the initial state (A), control is performed so as to output binary voltage pulses between the gradation levels 7 and 8, during the period 1.

As shown in FIG. 38, in the case where the gradation level is between 7 and 8, the corresponding output states for V4 are “0” and “1”, respectively. Therefore, the number of times of switching in the single-phase inverter that outputs V4 and which is the first common single-phase inverter, increases. As shown in FIG. 39, in the initial state (A), the first common voltage corresponding to V4 is greatest among the voltage absolute values. Therefore, in the initial state (A), switching loss in the single-phase inverter that outputs V4 increases.

As described above, in the present embodiment, the target number of times of switching of all the switching elements composing the single-phase inverter that outputs V4 in one cycle of the sinusoidal output value instruction waveform Oref is 0. Accordingly, from the initial state (A) in FIG. 39, adjustment control for the output voltage of each DC power supply is performed in accordance with the flowchart shown in FIG. 37. As described above, in the present embodiment, the number of times of adjustment (LMT) for the output voltage of each DC power supply is 10. FIG. 39 shows a case where the number of times of switching in the single-phase inverter that outputs V4 has reached the target number of times, i.e., 0, while the process in the control flow shown in FIG. 37 is performed ten times. Hereinafter, the state in which the target number of times of switching is reached and maintained through output voltage adjustment for each DC power supply is referred to as after adjustment (B).

As shown in FIG. 38, in the state after adjustment (B), setting of the voltage absolute values (=voltages of DC power supplies) V1 to V4 of the respective single-phase inverters has been made so that the maximum voltage of the whole output voltage Vsum becomes 145 V. In the present embodiment, the whole output voltage Vsum can be adjusted on a 5 V basis. Therefore, after the process in the control flow shown in FIG. 37 is performed three times, the number of times of switching in the single-phase inverter that outputs V4 reaches the target number of times of switching, i.e., 0.

In FIG. 38, the voltages (=voltage absolute values) of the DC power supplies after adjustment (B) are V1=13.18 V, V2=26.36 V, and V3=V4=52.72 V. Regarding V3 and V4 which are the first common voltage, the voltage is increased by 5.45 V from the initial state (A), and therefore the increase width of the adjusted voltage is small. As shown in FIG. 38, in the state after adjustment (B), in a case where equivalent voltage of the whole output voltage Vsum is controlled to be +90 V which is a positive peak value of the sinewave, PWM control is performed to form two voltage pulses between the gradation level 6 (79.09 V) and the gradation level 7 (92.27 V).

As shown in FIG. 39, in the state after adjustment (B), control is performed so as to output binary voltage pulses between the gradation levels 6 and 7, during the period 1. As shown in FIG. 38, in the case where the gradation level is between 6 and 7, the corresponding output states for V4 are “0” and “0”, respectively. Therefore, the number of times of switching in the single-phase inverter that outputs V4 which is the first common voltage is 0 in the period 1 and one cycle of Oref which is a sinewave. Thus, in a case where the output value instruction waveform Oref indicates an instruction to output a sinewave having peak voltage of +90 V as a steady waveform, the number of times of switching in the single-phase inverter that outputs V4 and is set as a target for which the number of times of switching is counted can be made to be the target number of times of switching, i.e., 0. As a result, it becomes possible to significantly reduce switching loss in the single-phase inverter that outputs V4.

In the present embodiment, the first common single-phase inverter as a counting target is the single-phase inverter that outputs V4, and the target number of times of switching is set for the total number of times of switching of all the switching elements composing the single-phase inverter that outputs V4. However, the counting target may be the number of times of switching of at least one switching element composing the first common single-phase inverter. Alternatively, in the waveform of V4 shown in FIG. 39, the number of output voltage pulses of the first common single-phase inverter as a counting target may be set as a target number of times.

In the present embodiment, the case where the number of the first common single-phase inverters as counting targets is one has been described. However, for example, in one cycle of the output value instruction waveform Oref which is a sinewave or the like, the sum of the numbers of times of switching in a plurality of first common single-phase inverters may be set as a target number of times of switching.

In the present embodiment, the example in which adjustment is performed in a direction to increase voltage of each DC power supply has been shown. However, adjustment may be performed in a direction to decrease voltage in accordance with the waveform of the output value instruction waveform Oref, or directions to decrease and increase voltage may be combined within a predetermined number of times of adjustment, to approach the target number of times of switching.

In the present embodiment, the case where the target number of times of switching is 0 which is the minimum value, has been shown. However, the target number of times of switching may be set as being not greater than a threshold, and the threshold may be set at 3, for example.

In the present embodiment, the example in which voltage of each DC power supply is adjusted on the basis of the flowchart shown in FIG. 37 has been shown. In a case where the waveform of the output value instruction waveform Oref which is outputted steadily and frequently has already been determined, the control shown in FIG. 37 may be manually or automatically performed in advance, to set voltage of each DC power supply in advance so that the target number of times of switching is reached when a steady waveform is outputted.

In the present embodiment, description has been given using the waveform example in the power conversion device that uses PWM control as described in embodiment 3. However, the above configuration can be applied also to a power conversion device that does not use PWM control. For example, in a case where the output value instruction waveform Oref is a ramp waveform having a DC offset so that the gradation level is repeatedly switched between 7 and 8 in the initial state (A), voltage control for the DC power supplies in the present embodiment can be applied.

As described above, in the power conversion device of the present embodiment, it is possible to adjust output voltage of the DC power supply of each single-phase inverter or set output voltage of each DC power supply in advance so that the number of times of switching in the target first common single-phase inverter becomes minimum or not greater than a threshold, in a state in which the ratios of the voltage absolute values of the included single-phase inverters are maintained. As a result, switching loss in the single-phase inverter whose output voltage is great is reduced, whereby it becomes possible to provide a power conversion device having a reduced size at reduced cost.

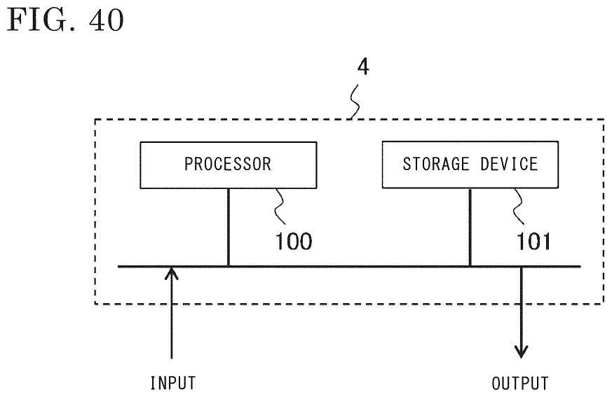

As shown in a hardware example in FIG. 40, the control unit 4 is composed of a processor 100 and a storage device 101. The storage device is provided with a volatile storage device such as a random access memory and a nonvolatile auxiliary storage device such as a flash memory, although not shown. Instead of the flash memory, an auxiliary storage device of a hard disk may be provided. The processor 100 executes a program inputted from the storage device 101. In this case, the program is inputted from the auxiliary storage device to the processor 100 via the volatile storage device. The processor 100 may output data such as a calculation result to the volatile storage device of the storage device 101, or may store such data into the auxiliary storage device via the volatile storage device.

The control unit 4 may be a digital controller such as a field programmable gate array (FPGA) or a microcontroller unit (MCU). Alternatively, the control unit 4 may be configured such that an analog circuit and a digital controller are combined using an analog circuit such as a comparator and an operational amplifier for the first subtractor 402 and the output polarity determination unit 404.

Although the disclosure is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations to one or more of the embodiments of the disclosure.

It is therefore understood that numerous modifications which have not been exemplified can be devised without departing from the scope of the present disclosure. For example, at least one of the constituent components may be modified, added, or eliminated. At least one of the constituent components mentioned in at least one of the preferred embodiments may be selected and combined with the constituent components mentioned in another preferred embodiment.

### DESCRIPTION OF THE REFERENCE CHARACTERS

1 power conversion device
2 single-phase inverter
3 DC power supply
4 control unit
5 output detection unit
6 AD converter
10 load
21, 22 half-bridge inverter
23 switching element
41 gradational control signal generation unit
42 gate driver
43 dead time generation unit
44 gate driving signal output unit
51 operational amplifier
52 resistor
53 current detection resistor
100 processor
101 storage device
401 output value instruction unit
402 first subtractor
403 compensator
404 output polarity determination unit
405 absolute-value-making processing unit
406 integer-making processing unit
407 second subtractor
408 pulse width modulation unit
409 adder
410 gradational control signal conversion unit

1. A power conversion device comprising:
three or more single-phase inverters each of which converts DC power to AC power; and
a controller which controls the single-phase inverters, wherein
the single-phase inverters are connected in series,
where absolute values of output voltages of the single-phase inverters are defined as voltage absolute values, the three or more single-phase inverters include at least two first common single-phase inverters which output first common voltages having the same voltage absolute value, and at least one single-phase inverter which outputs voltage having a smaller voltage absolute value than that of the first common voltages, and
the controller outputs total voltage of the output voltages of the single-phase inverters to a load.

2. The power conversion device according to claim 1, wherein
the first common voltages have the greatest value among the voltage absolute values of the three or more single-phase inverters.

3. The power conversion device according to claim 1, wherein
the single-phase inverters perform output while switching polarities of the voltage absolute values.

4. The power conversion device according to claim 1, wherein
regarding ratios of the voltage absolute values of the three or more single-phase inverters, where the ratio of the smallest voltage absolute value is defined as 1, the ratio of the first common voltage of each first common single-phase inverter is defined as J, and a sum of the ratios of the voltage absolute values of the single-phase inverters of which the ratios of the voltage absolute values are smaller than J is denoted as K, J=K+1 is satisfied.

5. The power conversion device according to claim 1, wherein
regarding ratios of the voltage absolute values of the three or more single-phase inverters, where the ratio of the smallest voltage absolute value is defined as 1, the ratio of the first common voltage of each first common single-phase inverter is defined as J, and a sum of the ratios of the voltage absolute values of the single-phase inverters of which the ratios of the voltage absolute values are smaller than J is denoted as K, J=2K+1 is satisfied.

6. The power conversion device according to claim 1, wherein
regarding ratios of the voltage absolute values of the three or more single-phase inverters, where the ratio of the smallest voltage absolute value is defined as 1, the controller performs PWM control for at least one of the single-phase inverters, so as to control the total voltage at a voltage resolution smaller than the ratio 1.

7. The power conversion device according to claim 1, wherein
the first common single-phase inverters each include one or more switching elements, and
the controller minimizes a difference between numbers of times of switching of the switching elements respectively included in the two or more first common single-phase inverters per unit time.

8. The power conversion device according to claim 4, wherein
regarding ratios of the voltage absolute values of the three or more single-phase inverters, where the ratio of the smallest voltage absolute value is defined as 1, the ratios of the voltage absolute values of the single-phase inverters include, at least, 1 and 2, or 1 and 3.

9. The power conversion device according to claim 5, comprising four or more said single-phase inverters, wherein
regarding ratios of the voltage absolute values of the four or more single-phase inverters, where the ratio of the smallest voltage absolute value is defined as 1, the ratios of the voltage absolute values of the single-phase inverters include at least 1, 3, and 9, and the voltage absolute value for the ratio 9 corresponds to the first common voltages.

10. The power conversion device according to claim 1, comprising four or more said single-phase inverters, wherein
the four or more single-phase inverters include at least two second common single-phase inverters which output second common voltages having the same voltage absolute value and being smaller than the first common voltages.

11. The power conversion device according to claim 10, wherein
the second common voltage has the smallest value among the voltage absolute values of the four or more single-phase inverters.

12. The power conversion device according to claim 10, wherein
the second common single-phase inverters each include one or more switching elements, and
the controller minimizes a difference between numbers of times of switching of the switching elements respectively included in the two or more second common single-phase inverters per unit time.

13. The power conversion device according to claim 7, wherein
a plurality of DC power supplies for supplying DC power are respectively connected to a plurality of the single-phase inverters,
the controller controls output voltages of the plurality of DC power supplies on the basis of at least one of target voltage to be applied to the load, target current to be supplied to the load, or target power to be supplied to the load, to minimize, for at least one of the first common single-phase inverters, a total number of times of switching of one or more of the switching elements composing the first common single-phase inverter per unit time, in a state in which ratios of the voltage absolute values of the plurality of single-phase inverters are maintained.
